(19) United States
(12) Patent Application Publication
(10) Pub. No.: US 2006/0181494 A1
(43) Pub. Date: Aug. 17, 2006

(54) Reference voltage generation circuit, display driver, electro-optical device, and electronic instrument

(75) Inventor: Akira Morita, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/346,532

(22) Filed: Feb. 2, 2006

(30) Foreign Application Priority Data
Feb. 17, 2005 (JP) 2005-40442

(51) Int. Cl. G09G 3/36

(52) U.S. Cl. 345/89

(57) ABSTRACT

A reference voltage generation circuit includes: a serial/parallel conversion circuit which converts serially input gamma correction data into parallel data of a given number of bits; a level shifter which converts a signal level of each bit of the parallel data; a gamma correction data register in which the gamma correction data is set in units of the number of bits; and a reference voltage select circuit which outputs K kinds of select voltages selected from first to Lth (L is an integer larger than two) select voltages arranged in potential descending order or potential ascending order based on the gamma correction data set in the gamma correction data register as first to Kth (K is a natural number smaller than L) reference voltages in potential descending order or potential ascending order.

Japanese Patent Application No. 2005-40442, filed on Feb. 17, 2005, is hereby incorporated by reference in its entirety.

### BACKGROUND OF THE INVENTION

The present invention relates to a reference voltage generation circuit, a display driver, an electro-optical device, and an electronic instrument.

An electro-optical device represented by a liquid crystal display (LCD) panel is widely provided in a portable electronic instrument and is required to display an image rich in color tone by increasing the number of grayscales.

An image signal for displaying an image is generally gamma-corrected corresponding to display characteristics of a display device. In an electro-optical device, a reference voltage corresponding to grayscale data which determines a grayscale value is selected from a plurality of reference voltages, and the pixel transmissivity is changed based on the selected reference voltage. Therefore, gamma correction is realized by changing the voltage level of each reference voltage.

The reference voltage is generated by dividing the voltage across a ladder resistor circuit by using resistor elements of the ladder resistor circuit, as disclosed in JP-A-2003-233354, JP-A-2003-233355, JP-A-2003-233356, and JP-A-2003-233357. Therefore, the voltage level of each reference voltage can be changed by changing the resistance of each resistor element.

However, more accurate gamma correction may be required due to an increase in resolution and diversification of an LCD panel. In this case, it is difficult to generate the reference voltage with high accuracy merely by changing the resistance of each resistor element of the ladder resistor circuit. In particular, when the type of LCD panel is changed, it is difficult to generate a highly accurate reference voltage corresponding to the LCD panel by using a simple configuration. Therefore, control and the configuration become complicated in order realize a plurality of types of gamma correction.

Gamma correction data for controlling gamma correction may be set in a reference voltage generation circuit. However, when the number of bits of gamma correction data is increased along with an increase in the number of grayscale levels, the time required to set the gamma correction data may be increased, or power consumption required to set the gamma correction data may be increased. Therefore, it is desirable that the gamma correction data be set at low power consumption even when the number of bits of gamma correction data is increased.

### SUMMARY

A first aspect of the invention relates to a reference voltage generation circuit which generates a plurality of reference voltages for performing gamma correction, the reference voltage generation circuit comprising:

a serial/parallel conversion circuit which converts serially input gamma correction data into parallel data of a given number of bits;

a level shifter which converts a signal level of each bit of the parallel data;

a gamma correction data register in which the gamma correction data of which the signal level has been converted by the level shifter is set in units of the number of bits; and

a reference voltage select circuit which outputs K kinds of select voltages selected from first to Lth (L is an integer larger than two) select voltages arranged in potential descending order or potential ascending order based on the gamma correction data set in the gamma correction data register as first to Kth (K is a natural number smaller than L) reference voltages in potential descending order or potential ascending order.

A second aspect of the invention relates to a display driver for driving data lines of an electro-optical device, the display driver comprising:

the above reference voltage generation circuit;

a voltage select circuit which selects a reference voltage corresponding to grayscale data from the first to Kth reference voltages from the reference voltage generation circuit, and outputs the selected reference voltage as a data voltage; and

a driver circuit which drives the data line based on the data voltage.

A third aspect of the invention relates to an electro-optical device comprising:

a plurality of scan lines;

a plurality of data lines;

a pixel electrode specified by one of the scan lines and one of the data lines;

a scan driver which scans the scan lines; and

the above display driver which drives the data lines.

A fourth aspect of the invention relates to an electronic instrument comprising the above display driver.

A fifth aspect of the invention relates to an electronic instrument comprising the above electro-optical device.

### BRIEF DESCRIPTION OF THE SEVERAL VIEWS OF THE DRAWING

FIG. 1 shows an outline of a configuration of a liquid crystal display device according to one embodiment of the invention.

FIG. 2 shows another outline of a configuration of a liquid crystal display device according to one embodiment of the invention.

FIG. 3 shows a configuration example of a gate driver shown in FIG. 1.

FIG. 4 is a block diagram of a configuration example of a data driver shown in FIG. 1.

FIG. 5 shows an outline of a configuration of a reference voltage generation circuit, a DAC, and a driver circuit shown in FIG. 4.

FIG. 6 shows an outline of an EEPROM according to one embodiment of the invention.

FIG. 7 is a timing diagram of a read control example of the EEPROM.

FIG. 8 is a block diagram of a configuration example of a reference voltage generation circuit according to one embodiment of the invention.

FIG. 9 is illustrative of gamma correction data according to one embodiment of the invention.

FIG. 10 shows a configuration example of a gamma correction data register and a gamma correction data setting circuit shown in FIG. 8.

FIG. 11 is a timing diagram of an operation example of the gamma correction data setting circuit shown in FIG. 10.

FIG. 12 is illustrative of an operation example of a reference voltage select circuit shown in FIG. 8.

FIG. 13 is illustrative of gamma characteristics.

FIG. 14 is a block diagram of a configuration example of a reference voltage select circuit in a comparative example of one embodiment of the invention.

FIG. 15 is a block diagram of a configuration example of a reference voltage select circuit according to one embodiment of the invention.

FIGS. 16A and 16B are illustrative of an enable signal and a disable signal output from a switch cell to other switch cells.

FIG. 17 shows an operation example of the reference voltage select circuit shown in FIG. 15.

FIG. 18 shows a specific circuit configuration example of the reference voltage select circuit according to one embodiment of the invention.

FIG. 19 is an enlarged diagram of a part of the circuit diagram of FIG. 18.

FIG. 20 shows a circuit configuration example of a switch cell shown in FIG. 19.

FIG. 21 is a block diagram of a configuration example of a gamma correction data setting circuit according to a modification of one embodiment of the invention.

FIG. 22 is a block diagram of a configuration example of an electronic instrument according to one embodiment of the invention.

### DETAILED DESCRIPTION OF THE EMBODIMENT

The invention may provide a reference voltage generation circuit, a display driver, an electro-optical device, and an electronic instrument for realizing highly accurate gamma correction by using a simple configuration.

The invention may further provide a reference voltage generation circuit, a display driver, an electro-optical device, and an electronic instrument in which gamma correction data for performing highly accurate gamma correction at low power consumption can be set.

One embodiment of the invention provides a reference voltage generation circuit which generates a plurality of reference voltages for performing gamma correction, the reference voltage generation circuit comprising:

a serial/parallel conversion circuit which converts serially input gamma correction data into parallel data of a given number of bits;

a level shifter which converts a signal level of each bit of the parallel data;

a gamma correction data register in which the gamma correction data of which the signal level has been converted by the level shifter is set in units of the number of bits; and

a reference voltage select circuit which outputs K kinds of select voltages selected from first to Lth (L is an integer larger than two) select voltages arranged in potential descending order or potential ascending order based on the gamma correction data set in the gamma correction data register as first to Kth (K is a natural number smaller than L) reference voltages in potential descending order or potential ascending order.

The reference voltage generation circuit according to this embodiment may include:

a shift register including a plurality of flip-flops connected in series and performing a shift operation in synchronization with a clock signal to output shift outputs in units of the number of bits,

the data of each bit of the gamma correction data may be input in synchronization with the clock signal; and

the gamma correction data of which the signal level has been converted by the level shifter may be set in the gamma correction data register based on the shift outputs output in units of the number of bits.

The reference voltage generation circuit according to this embodiment may include:

an address generation circuit which generates an address for designating a write area of the gamma correction data register; and

the gamma correction data of which the signal level has been converted by the level shifter may be set in the gamma correction data register based on the address generated by the address generation circuit.

According to any of the above reference voltage generation circuits, the serially input gamma correction data can be converted into the parallel data and set in the gamma correction data register. Therefore, instead of writing the gamma correction data in the gamma correction data register at high speed while generating clock signals in the number of bits of the gamma correction data, the gamma correction data can be written into the gamma correction data register at low speed while generating a smaller number of clock signals. This significantly reduces power consumption required to set the gamma correction data.

Moreover, since it suffices that the level shifter convert the signal levels in the number of bits of the parallel data, an increase in the circuit scale can be prevented.

The reference voltage generation circuit may include:

first to Kth impedance conversion circuits to which the K kinds of select voltages selected by the reference voltage select circuit are respectively supplied at an input of each impedance conversion circuit; and

outputs of the first to Kth impedance conversion circuits may be output as the first to Kth reference voltages.

According to one embodiment of the invention, in addition to achieving the above-described effects, it is possible to prevent an increase in the charging time of the signal line to which the reference voltage is supplied due to an increase in impedance from a power supply line of a select voltage generation circuit.

With the reference voltage generation circuit according to this embodiment, the gamma correction data may be L-bit data, the data of each bit of the L-bit data being associated with one of the select voltages and indicating whether or not to output the one of the select voltages as one of the reference voltages.

With the reference voltage generation circuit according to this embodiment,

the reference voltage select circuit may include:

a first switch element for outputting the first select voltage as the first reference voltage;

a second switch element for outputting the second select voltage as the first reference voltage;

a third switch element for outputting the second select voltage as the second reference voltage; and

a fourth switch element for outputting the third select voltage as the second reference voltage;

the first switch element may output the first select voltage as the first reference voltage on condition that the first switch element is enabled by the data of the first bit of the gamma correction data;

the second switch element may output the second select voltage as the first reference voltage on condition that the second switch element is disabled by the data of the first bit of the gamma correction data and enabled by the data of the second bit of the gamma correction data;

the third switch element may output the second select voltage as the second reference voltage on condition that the third switch element is enabled by the data of the first bit of the gamma correction data and enabled by the data of the second bit of the gamma correction data;

the fourth switch element may output the third select voltage as the second reference voltage on condition that the fourth switch element is enabled by the data of the first bit of the gamma correction data, disabled by the data of the second bit of the gamma correction data, and enabled by the data of the third bit of the gamma correction data; and

the reference voltage select circuit may output at least the first and second reference voltages of the first to Kth reference voltages.

The reference voltage generation circuit according to this embodiment may include:

first to fourth switch cells respectively including the first to fourth switch elements;

the first switch cell may activate a disable signal to the second switch cell and may activate an enable signal to the third switch cell when the first switch cell is enabled by the data of the first bit of the gamma correction data, and may deactivate the disable signal to the second switch cell and may deactivate the enable signal to the third switch cell when the first switch cell is disabled by the data of the first bit of the gamma correction data;

the second switch cell may output the second select voltage as the first reference voltage and may activate the enable signal to the fourth switch cell on condition that the second switch cell is enabled by the data of the second bit of the gamma correction data and the disable signal from the first switch cell is inactive, and the second switch cell may deactivate the enable signal to the fourth switch cell in other cases;

the third switch cell may output the second select voltage as the second reference voltage and may activate the disable signal to the fourth switch cell on condition that the third switch cell is enabled by the data of the second bit of the gamma correction data and the enable signal from the first switch cell is active, and the third switch cell may deactivate the disable signal to the fourth switch cell in other cases; and

the fourth switch cell may output the third select voltage as the second reference voltage on condition that the fourth switch cell is enabled by the data of the third bit of the gamma correction data, the disable signal from the third switch cell is inactive, and the enable signal from the second switch cell is active.

With the reference voltage generation circuit according to this embodiment,

the reference voltage select circuit may include:

a first switch cell including a first switch element for outputting the first select voltage as the first reference voltage;

a second switch cell including a second switch element for outputting the second select voltage as the first reference voltage;

a third switch cell including a third switch element for outputting the second select voltage as the second reference voltage; and

a fourth switch cell including a fourth switch element for outputting the third select voltage as the second reference voltage;

the first switch cell may be provided with the data of the first bit of the gamma correction data and may output an enable signal to the second and third switch cells;

the second switch cell may be provided with the data of the second bit of the gamma correction data and may output the enable signal to the third and fourth switch cells;

the third switch cell may be provided with the data of the second bit of the gamma correction data and may output the enable signal to the fourth switch cell;

the fourth switch cell may be provided with the data of the third bit of the gamma correction data; and

the reference voltage select circuit may output at least the first and second reference voltages of the first to Kth reference voltages.

According to any of the above reference voltage generation circuits, in addition to achieving the above-described effects, the reference voltage select circuit includes at least the first to fourth switch elements and makes it unnecessary to provide a switch element for outputting the first select voltage as the second reference voltage. Moreover, when outputting only the first and second reference voltages, a switch element for outputting the third select voltage as the first reference voltage can be omitted. Therefore, a reference voltage select circuit which can select the reference voltage for realizing highly accurate gamma correction by using a simple configuration can be provided.

One embodiment of the invention provides a display driver for driving data lines of an electro-optical device, the display driver comprising:

any one of the above reference voltage generation circuits;

a voltage select circuit which selects a reference voltage corresponding to grayscale data from the first to Kth reference voltages from the reference voltage generation circuit, and outputs the selected reference voltage as a data voltage; and

a driver circuit which drives the data line based on the data voltage.

According to one embodiment of the invention, a display driver which realizes highly accurate gamma correction at low power consumption by using a simple configuration can be provided.

One embodiment of the invention provides an electro-optical device comprising:

a plurality of scan lines;

a plurality of data lines;

a pixel electrode specified by one of the scan lines and one of the data lines;

a scan driver which scans the scan lines; and

the above display driver which drives the data lines.

According to one embodiment of the invention, an electro-optical device which realizes highly accurate gamma correction at low power consumption by using a simple configuration can be provided.

One embodiment of the invention provides an electronic instrument comprising the above display driver.

One embodiment of the invention provides an electronic instrument comprising the above electro-optical device.

According to the above embodiments of the invention, an electronic instrument including a reference voltage generation circuit which realizes highly accurate gamma correction at low power consumption by using a simple configuration can be provided.

Note that the embodiments described hereunder do not in any way limit the scope of the invention defined by the claims laid out herein. Note also that not all of the elements of these embodiments should be taken as essential requirements to the means of the present invention.

1. Liquid Crystal Display Device

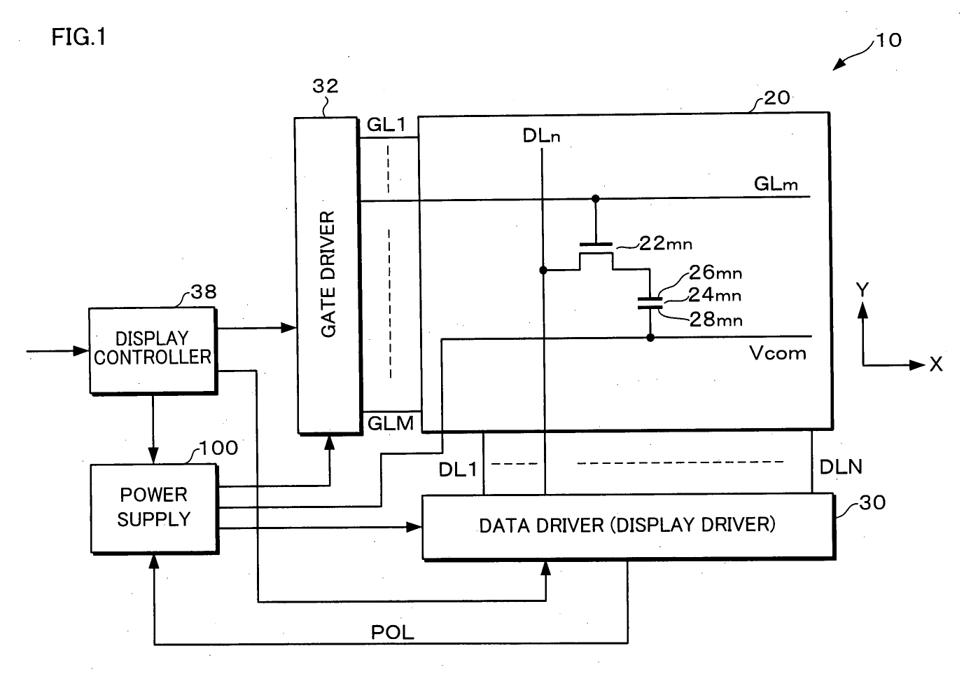

FIG. 1 shows an outline of a configuration of an active matrix type liquid crystal display device according to one embodiment of the invention. Note that a data driver (display driver) including a reference voltage select circuit according to one embodiment of the invention may be applied to a simple matrix type liquid crystal display device instead of an active matrix type liquid crystal display device described below.

A liquid crystal display device 10 includes an LCD panel (display panel in a broad sense; electro-optical device in a broader sense) 20. The LCD panel 20 is formed on a glass substrate, for example. A plurality of scan lines (gate lines) GL1 to GLM (M is an integer larger than one), arranged in a direction Y and extending in a direction X, and a plurality of data lines (source lines) DL1 to DLN (N is an integer larger than one), arranged in the direction X and extending in the direction Y, are disposed on the glass substrate. A pixel area (pixel) is provided corresponding to the intersecting point of the scan line GLm (1≦m≦M, m is an integer; hereinafter the same) and the data line DLn (1≦n≦N, n is an integer; hereinafter the same). A thin film transistor (hereinafter abbreviated as “TFT”) 22mn is disposed in the pixel area.

The gate of the TFT 22mn is connected with the scan line GLn. The source of the TFT 22mn is connected with the data line DLn. The drain of the TFT 22mn is connected with a pixel electrode 26mn. A liquid crystal is sealed between the pixel electrode 26mn and a common electrode 28mn opposite to the pixel electrode 26mn so that a liquid crystal capacitor 24mn (liquid crystal element in a broad sense) is formed. The transmissivity of the pixel changes corresponding to the voltage applied between the pixel electrode 26mn and the common electrode 28mn. A common electrode voltage Vcom is supplied to the common electrode 28mn.

The LCD panel 20 is formed by attaching a first substrate on which the pixel electrode and the TFT are formed to a second substrate on which the common electrode is formed, and sealing a liquid crystal as an electro-optical substance between the substrates, for example.

The liquid crystal display device 10 includes a data driver (display driver in a broad sense) 30. The data driver 30 drives the data lines DL1 to DLN of the LCD panel 20 based on grayscale data.

The liquid crystal display device 10 may include a gate driver (scan driver in a broad sense) 32. The gate driver 32 scans the scan lines GL1 to GLM of the LCD panel 20 within one vertical scan period.

The liquid crystal display device 10 may include a power supply circuit 100. The power supply circuit 100 generates voltages necessary for driving the data lines, and supplies the generated voltages to the data driver 30. The power supply circuit 100 generates power supply voltages VDDH and VSSH necessary for the data driver 30 to drive the data lines and voltages for a logic section of the data driver 30, for example.

The power supply circuit 100 generates voltage necessary for driving (scanning) the scan lines, and supplies the generated voltage to the gate driver 32.

The power supply circuit 100 generates the common electrode voltage Vcom. The power supply circuit 100 outputs the common electrode voltage Vcom, which periodically changes between a high-potential-side voltage VCOMH and a low-potential-side voltage VCOML in synchronization with the timing of a polarity reversal signal POL generated by the data driver 30, to the common electrode of the LCD panel 20.

The liquid crystal display device 10 may include a display controller 38. The display controller 38 controls the data driver 30, the gate driver 32, and the power supply circuit 100 according to the content set by a host (not shown) such as a central processing unit (hereinafter abbreviated as “CPU”). For example, the display controller 38 sets the operation mode of the data driver 30 and the gate driver 32 and supplies a vertical synchronization signal and a horizontal synchronization signal generated therein to the data driver 30 and the gate driver 32. In one embodiment of the invention, gamma correction data is read from a nonvolatile memory provided outside the data driver 30 during initialization. However, the display controller 38 may supply gamma correction data to the data driver 30 to implement various types of gamma correction.

In FIG. 1, the liquid crystal display device 10 is configured to include the power supply circuit 100 and the display controller 38. However, at least one of the power supply circuit 100 and the display controller 38 may be provided outside the liquid crystal display device 10. Or, the liquid crystal display device 10 may be configured to include the host.

The data driver 30 may include at least one of the gate driver 32 and the power supply circuit 100.

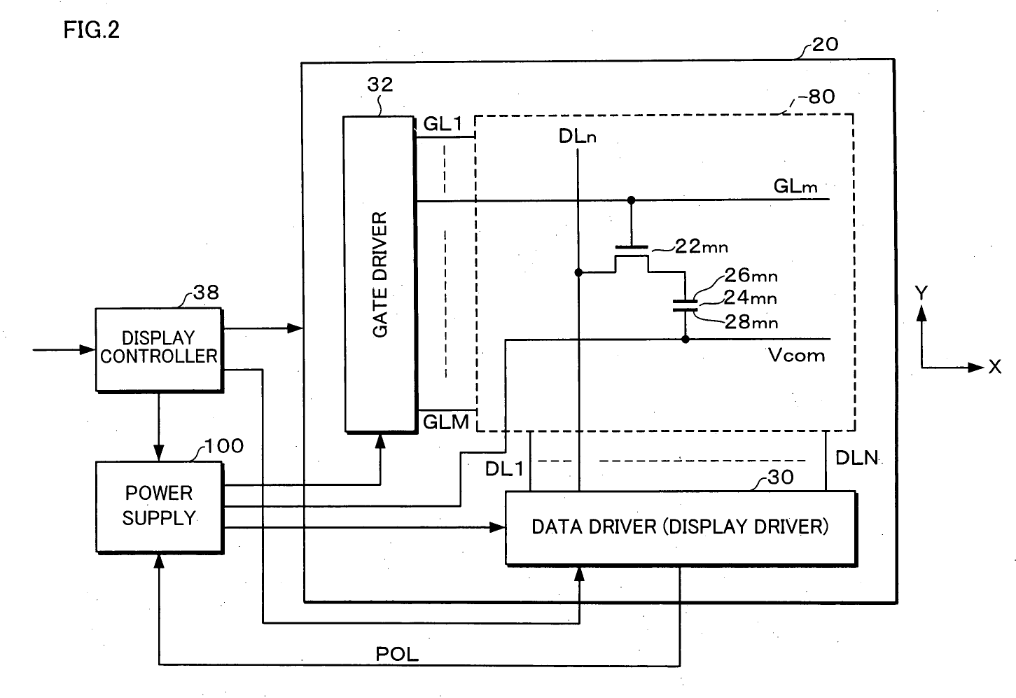

Some or all of the data driver 30, the gate driver 32, the display controller 38, and the power supply circuit 100 may be formed on the LCD panel 20. In FIG. 2, the data driver 30 and the gate driver 32 are formed on the LCD panel 20. Specifically, the LCD panel 20 may be configured to include a plurality of data lines, a plurality of scan lines, a plurality of switch elements, each of which is connected with one of the scan lines and one of the data lines, and a display driver which drives the data lines. Pixels are formed in a pixel formation area 80 of the LCD panel 20.

2. Gate Driver

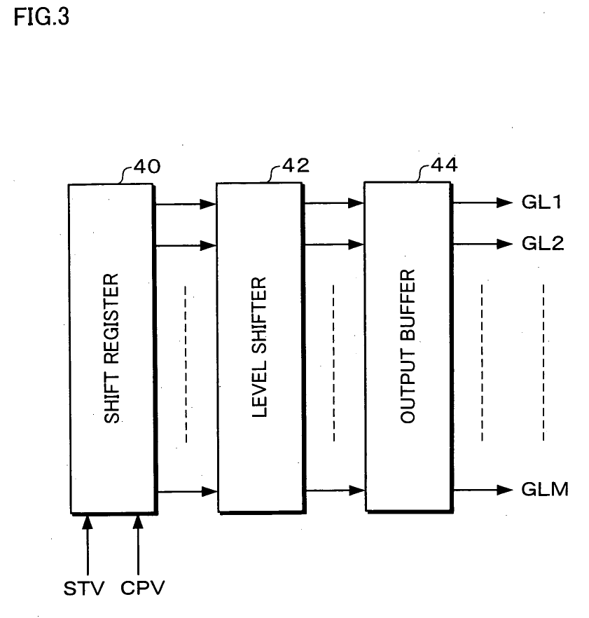

FIG. 3 shows a configuration example of the gate driver 32 shown in FIG. 1.

The gate driver 32 includes a shift register 40, a level shifter 42, and an output buffer 44.

The shift register 40 includes a plurality of flip-flops provided corresponding to the scan lines and connected in series. The shift register 40 holds a start pulse signal STV in the flip-flop in synchronization with a clock signal CPV, and sequentially shifts the start pulse signal STV to the adjacent flip-flops in synchronization with the clock signal CPV. The input clock signal CPV is a horizontal synchronization signal, and the start pulse signal STV is a vertical synchronization signal.

The level shifter 42 shifts the level of the voltage from the shift register 40 to the voltage level corresponding to the liquid crystal element of the LCD panel 20 and the transistor performance of the TFT. The voltage level needs to be as high 20 to 50 V, for example.

The output buffer 44 buffers a scan voltage shifted by the level shifter 42 and drives the scan line by outputting the scan voltage to the scan line.

3. Data Driver

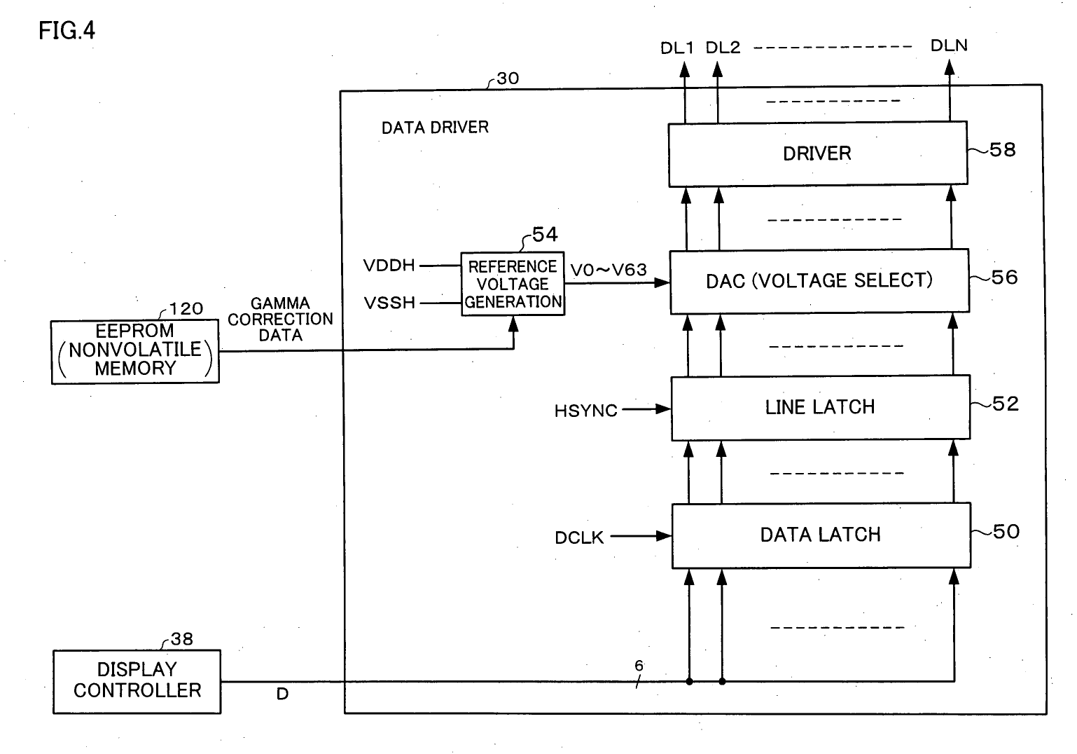

FIG. 4 is a block diagram showing a configuration example of the data driver 30 shown in FIG. 1. In FIG. 4, the number of bits of grayscale data per dot is six. However, the number of bits of grayscale data is not limited to six.

The data driver 30 includes a data latch 50, a line latch 52, a reference voltage generation circuit 54, a digital/analog converter (DAC) (voltage select circuit in a broad sense) 56, and a driver circuit 58.

Grayscale data is serially input to the data driver 30 in pixel units (or dot units). The grayscale data is input in synchronization with a dot clock signal DCLK. The dot clock signal DCLK is supplied from the display controller 38. In FIG. 4, the grayscale data is input in dot units for convenience of description.

The data latch 50 shifts a capture start signal in synchronization with the dot clock signal DCLK, and latches the grayscale data in synchronization with the shift output to acquire the grayscale data for one horizontal scan, for example.

The line latch 52 latches the grayscale data for one horizontal scan latched by the data latch 50 at the change timing of a horizontal synchronization signal HSYNC.

The reference voltage generation circuit 54 generates a plurality of reference voltages, each of which respectively corresponds to the grayscale data. In more detail, the reference voltage generation circuit 54 generates first to Kth (K is an integer larger than one) reference voltages arranged in potential descending order or potential ascending order. In this case, the reference voltage generation circuit 54 generates first to Lth (L is an integer greater than K) select voltages arranged in potential descending order or potential ascending order, and outputs K select voltages selected from the first to Lth select voltages based on the L-bit gamma correction data as the first to Kth reference voltages in potential descending order or potential ascending order. The data of each bit of the gamma correction data corresponds to one of the select voltages, and indicates whether or not to output the select voltage as the reference voltage.

The following description is given on the assumption that L is 256 and K is 64. In this case, the reference voltage generation circuit 54 generates reference voltages V0 to V63, each of which corresponds to 6-bit grayscale data, based on the high-potential-side power supply voltage VDDH and the low-potential-side power supply voltage VSSH. The reference voltage generation circuit 54 generates select voltages V_{G}0 to V_{G}255 by dividing the voltage between the high-potential-side power supply voltage VDDH and the low-potential-side power supply voltage VSSH, and outputs 64 select voltages selected from the select voltages V_{G}0 to V_{G}255 based on the gamma correction data as the reference voltages V0 to V63.

The DAC 56 generates data voltages corresponding to the grayscale data output from the line latch 52 in output line units. In more detail, the DAC 56 selects the reference voltage corresponding to the grayscale data for one output line, which is output from the line latch 52, from the reference voltages V0 to V63 generated by the reference voltage generation circuit 54, and outputs the selected reference voltage as the data voltage.

The driver circuit 58 drives the output lines connected with the data lines of the LCD panel 20. In more detail, the driver circuit 58 drives the output line based on the data voltage generated by the DAC 56 in output line units. Specifically, the driver circuit 58 drives the data line based on the data voltage which is the reference voltage selected based on the grayscale data. The driver circuit 58 includes voltage-follower-connected operational amplifiers provided in output line units, and the operational amplifier drives the output line based on the data voltage from the DAC 56.

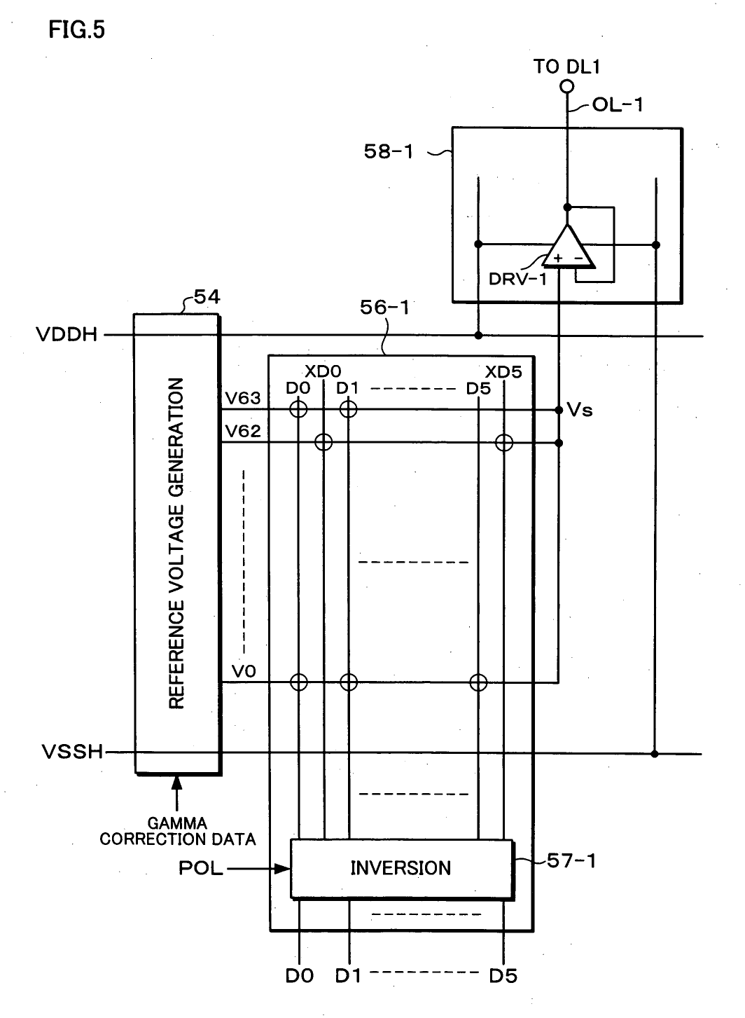

FIG. 5 shows an outline of a configuration of the reference voltage generation circuit 54, the DAC 56, and the driver circuit 58. FIG. 5 shows only the configuration of the driver circuit 58 which drives an output line OL-1 electrically connected with the data line DL1. However, the following description also applies to other output lines.

The reference voltage generation circuit 54 outputs voltages generated by dividing the voltage between the high-potential-side power supply voltage VDDH and the low-potential-side power supply voltage VSSH by using a resistor circuit as the reference voltages V0 to V63. In a polarity inversion drive, since the positive voltages and the negative voltages are not symmetrical, the reference voltage generation circuit 54 generates the positive reference voltages and the negative reference voltages. FIG. 5 shows either the positive-reference voltages or the negative reference voltages.

A DAC 56-1 may be realized by using a ROM decoder circuit. The DAC 56-1 selects one of the reference voltages V0 to V63 based on the 6-bit grayscale data, and outputs the selected reference voltage to an operational amplifier DRV-1 as a select voltage Vs. The voltages selected based on the corresponding 6-bit grayscale data are similarly output to other operational amplifiers DRV-2 to DRV-N.

The DAC 56-1 includes an inversion circuit 57-1. The inversion circuit 57-1 reverses the grayscale data based on the polarity reversal signal POL. 6-bit grayscale data D0 to D5 and 6-bit inversion grayscale data XD0 to XD5 are input to the DAC 56-1. The inversion grayscale data XD0 to XD5 is generated by reversing the grayscale data D0 to D5, respectively. The DAC 56-1 selects one of the multi-valued reference voltages V0 to V63 generated by the reference voltage generation circuit 54 based on the grayscale data.

When the logic level of the polarity reversal signal POL is “H”, the reference voltage V2 is selected corresponding to the 6-bit grayscale data D0 to D5 set at “000010” (=2), for example. When the logic level of the polarity reversal signal POL is “L”, the reference voltage is selected by using the inversion grayscale data XD0 to XD5 generated by reversing the grayscale data D0 to D5. Specifically, the inversion display data XD0 to XD5 is set at “111101” (=61) so that the reference voltage V61 is selected.

The select voltage Vs selected by the DAC 56-1 is supplied to the operational amplifier DRV-1.

The operational amplifier DRV-1 drives the output line OL-1 based on the select voltage Vs. The power supply circuit 100 changes the voltage of the common electrode in synchronization with the polarity reversal signal POL as described above. The polarity of the voltage applied to the liquid crystal is reversed in this manner.

In FIG. 4, the gamma correction data is stored in advance in an electrically erasable programmable read only memory (EEPROM) as a nonvolatile memory provided inside or outside of the data driver 30. The data stored in the EEPROM can be electrically rewritten. The data driver 30 reads the gamma correction data from an EEPROM 120 during predetermined initialization which starts after reset.

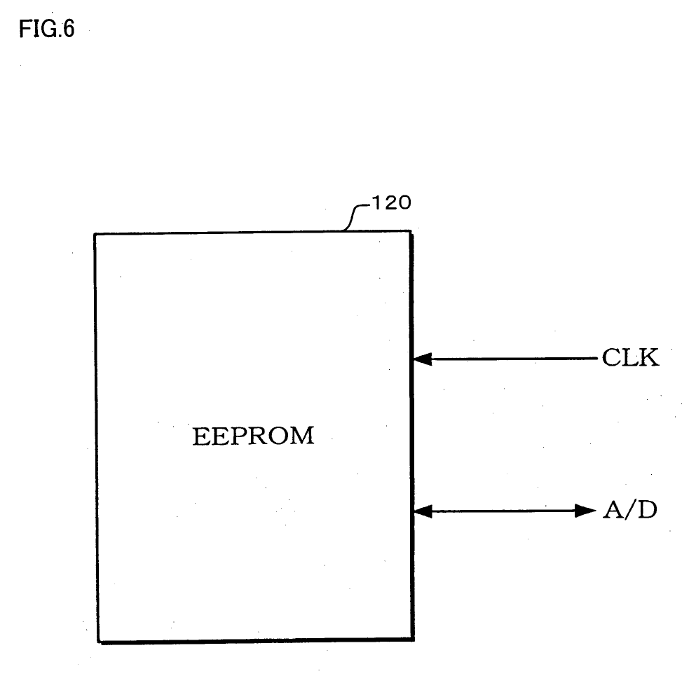

FIG. 6 shows an outline of a configuration of the EEPROM 120.

An address/data division bus and a clock signal line are connected with the EEPROM 120. The address/data division bus and the clock signal line are connected with the data driver 30.

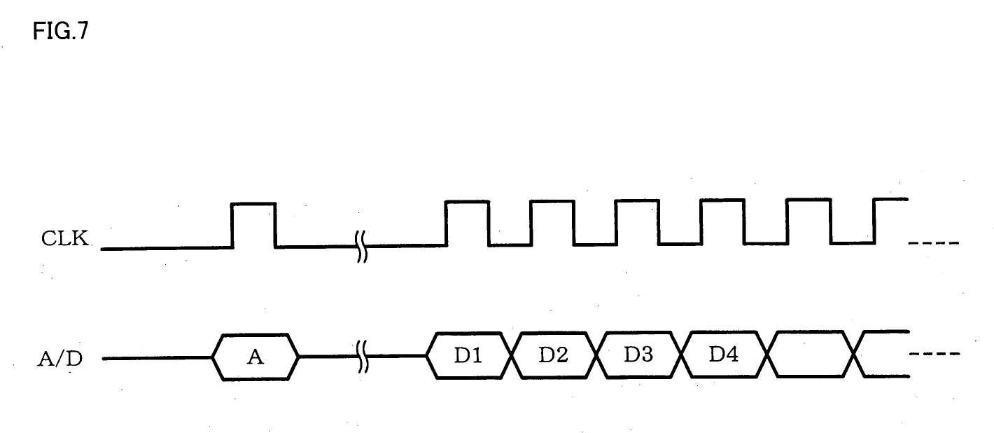

FIG. 7 is a timing diagram of a read control example of the EEPROM 120.

The data driver 30 sets address data A in the EEPROM 120 by outputting the address data A to the address/data division bus and outputting one clock pulse to the clock signal line, for example. The address data A indicates an address in a memory space of the EEPROM 120 in which control data (e.g. gamma correction data) read by the data driver 30 is stored.

The data driver 30 then sequentially supplies clock pulses to the clock signal line. The EEPROM 120 increments the stored address data A in synchronization with the clock signal. The stored data (control data) corresponding to the address data A is output to the address/data division bus in synchronization with the clock signal on the clock signal line.

In one embodiment of the invention, the data driver 30 reads the gamma correction data from the EEPROM 120 during initialization as described with reference to FIG. 7, and sets the gamma correction data in a gamma correction data register included in the reference voltage generation circuit 54.

4. Reference Voltage Generation Circuit

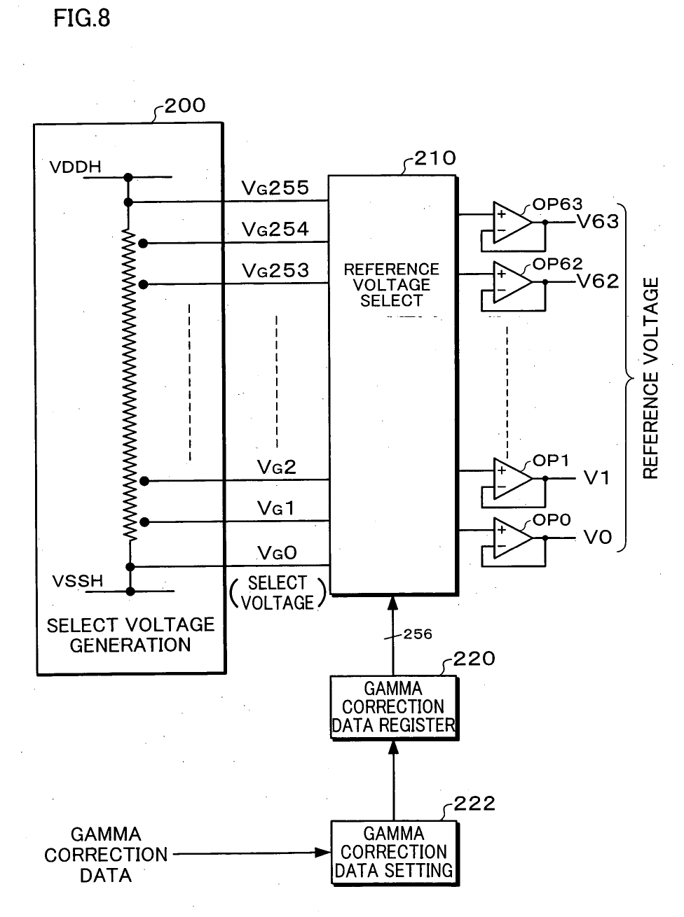

FIG. 8 is a block diagram of a configuration example of the reference voltage generation circuit 54 according to one embodiment of the invention.

The reference voltage generation circuit 54 includes a select voltage generation circuit 200, a reference voltage select circuit 210, a gamma correction data register 220, and a gamma correction data setting circuit 222.

The select voltage generation circuit 200 includes a ladder resistor circuit to which the high-potential-side power supply voltage VDDH and the low-potential-side power supply voltage VSSH are supplied at either end. The ladder resistor circuit includes a plurality of resistor elements connected in series. The select voltage is output from an output node at which the resistor elements are electrically connected. It is preferable that the resistance of each resistor element be changed by control from the host or the display controller 38.

The select voltage generation circuit 200 outputs the select voltages V_{G}0 to V_{G}255 (first to Lth select voltages) arranged in potential ascending order. The select voltage generation circuit 200 may output the select voltages V_{G}0 to V_{G}255 arranged in potential descending order.

The L-bit gamma correction data is set in the gamma correction data register 220, the data of each bit of the gamma correction data being associated with one of the select voltages and indicating whether or not to output the select voltage as the reference voltage.

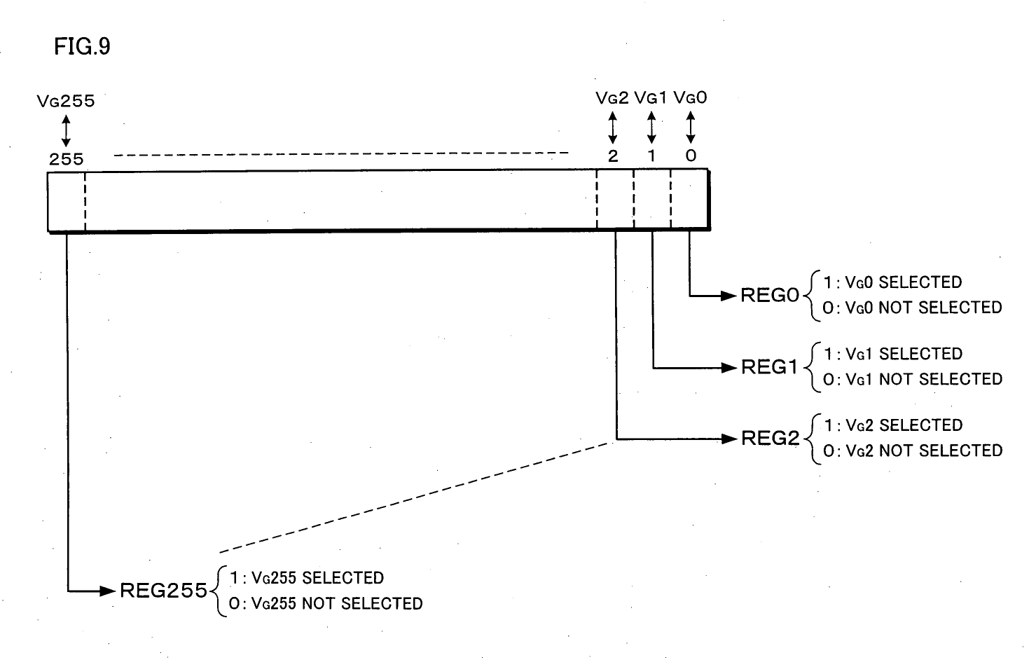

FIG. 9 is a diagram illustrative of the gamma correction data according to one embodiment of the invention.

When the number of select voltages is L, the gamma correction data has an L-bit configuration. Therefore, the gamma correction data shown in FIG. 8 has a 256-bit configuration. The data of each bit of the gamma correction data indicates whether or not to output the corresponding select voltage as the reference voltage. In one embodiment of the invention, the data of a bit set at “1” indicates that the select voltage corresponding to the bit is output as the reference voltage, and the data of a bit set at “0” indicates that the select voltage corresponding to the bit is not output as the reference voltage. Therefore, in the gamma correction data having a 256-bit configuration, only the data of arbitrary 64 bits of the 256 bits is set at “1”, and the remaining data is set at

In FIG. 9, the data of the 255th bit (most significant bit) of the gamma correction data is REG255, and the data of the 0th bit (least significant bit) of the gamma correction data is REG0.

In FIG. 8, the gamma correction data setting circuit 222 converts the gamma correction data serially input in bit units into parallel data having an 8-bit configuration, and sets the parallel data in the gamma correction data register 220. Therefore, it suffices to set the parallel data 32 times in the gamma correction data register 220 when the gamma correction data is made up of 256 bits. Therefore, it suffices to write the gamma correction data in the gamma correction data register 220 at low speed in synchronization with 32 write pulses instead of writing the gamma correction data in the gamma correction data register 220 at high speed in synchronization with 256 write pulses, for example. This significantly reduces power consumption required to set the gamma correction data.

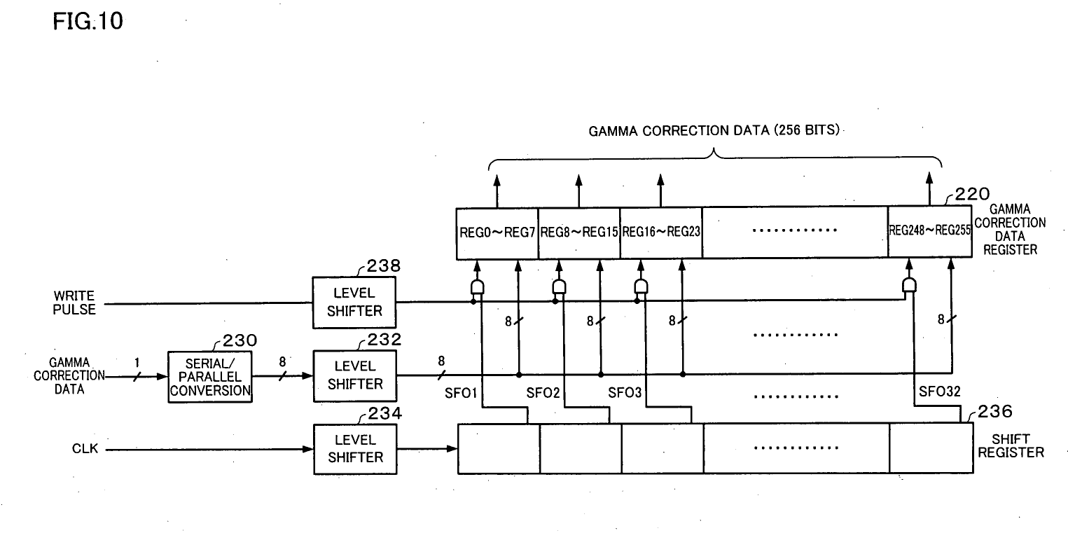

FIG. 10 shows a configuration example of the gamma correction data register 220 and the gamma correction data setting circuit 222 shown in FIG. 8.

The gamma correction data setting circuit 222 may include a serial/parallel conversion circuit 230, level shifters 232, 234, and 238, and a shift register 236.

The serial/parallel conversion circuit 230 converts the gamma correction data serially input in bit units into 8-bit parallel data. The level shifter 232 converts the signal level of each bit of the parallel data. Specifically, the level shifter 232 converts the signal level of each bit of the parallel data which oscillates between the low-amplitude logic power supply voltage so that the signal level of each bit of the parallel data oscillates between the high-amplitude liquid crystal drive power supply voltage.

The shift register 236 includes a plurality of flip-flops connected in series, and performs a shift operation in synchronization with a clock signal CLK as an input synchronization clock signal for the data of each bit of the gamma correction data to output shift outputs SFO1, SFO2, . . . , SFO32 in eight bit units. Therefore, the shift register 236 includes 256 flip-flops connected in series. The shift register 236 shifts a given start pulse in synchronization with the clock signal CLK. In FIG. 10, the clock signal CLK is input to the shift register 236 after the level shifter 234 has converted the signal level of the clock signal CLK.

The level shifter 238 converts the signal level of the write pulse. The write pulse of which the signal level has been converted is mask-controlled by using the shift outputs SFO1, SFO2, . . . , SFO32. The output of the level shifter 232 is set in the gamma correction data register 220 in eight bit units by using the mask-controlled signal.

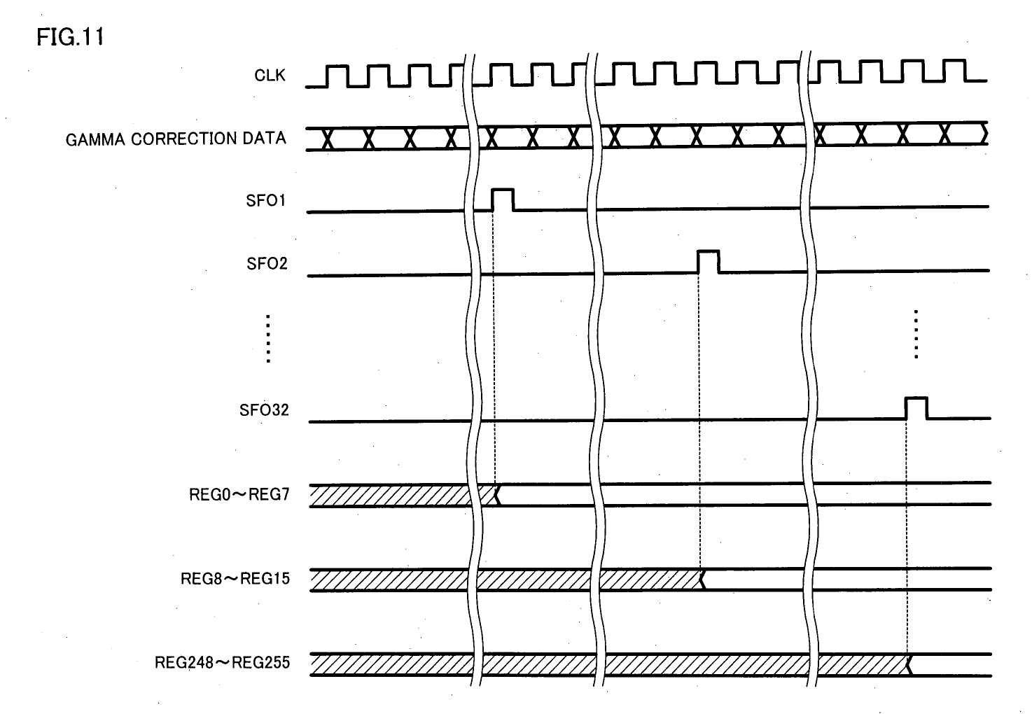

FIG. 11 is a timing diagram of an operation example of the gamma correction data setting circuit 222 shown in FIG. 10.

Specifically, the serially input gamma correction data is converted into 8-bit parallel data. The shift output is output in units of eight bits of the gamma correction data, and set in the gamma correction data register 220 in eight bit units.

In FIG. 8, the reference voltage select circuit 210 outputs 64 (=K) select voltages selected from the select voltages V_{G}0 to V_{G}255 (first to Lth select voltages) based on the gamma correction data as the reference voltages V0 to V63 (first to Kth reference voltages) in potential ascending order. The reference voltage select circuit 210 may output the reference voltages V0 to V63 arranged in potential descending order.

It is preferable that the reference voltage generation circuit 54 include first to Kth impedance conversion circuits to which the first to Kth reference voltages are respectively supplied at an input of each impedance conversion circuit. Specifically, it is preferable that the reference voltage generation circuit 54 shown in FIG. 8 include impedance conversion circuits OP0, OP1, . . . , OP63 to which the output of the reference voltage select circuit 210 is supplied at an input. The impedance conversion circuit is formed by using a voltage-follower-connected operational amplifier, for example. Therefore, the reference voltages are subjected to impedance conversion by the impedance conversion circuits OP0 to OP63 and supplied to the DAC 56. Therefore, it is possible to prevent an increase in the charging time of each signal line due to an increase in impedance from the signal line to which the high-potential-side or low-potential-side power supply voltage of the select voltage generation circuit is supplied to the reference voltage select circuit 210 and the DAC 56.

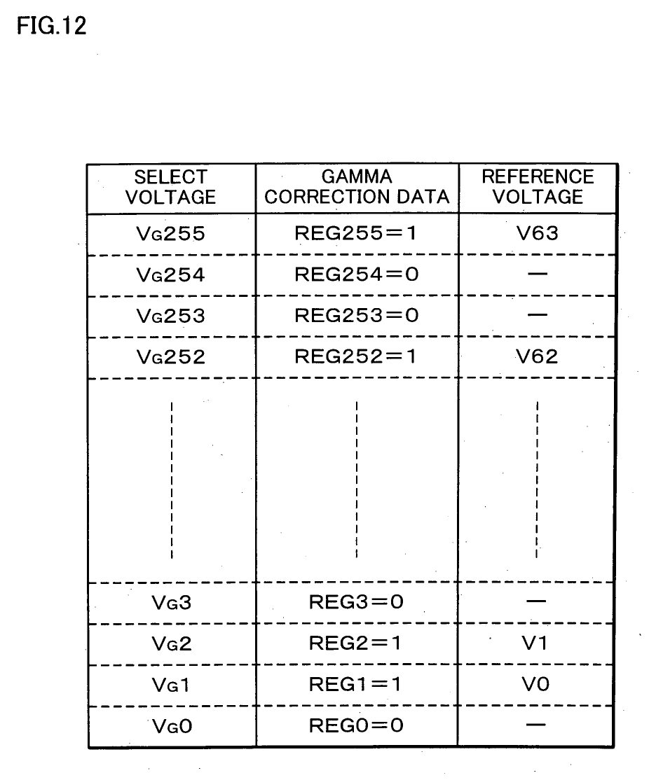

FIG. 12 is a diagram illustrative of an operation example of the reference voltage select circuit shown in FIG. 8.

In FIG. 12, the least significant bit of the gamma correction data is set at “0”, the second lowest bit is set at “1”, the third lowest bit is set at “1”, and the most significant bit is set at “1”. Since the least significant bit of the gamma correction data is set at “0”, the select voltage V_{G}0 corresponding to the least significant bit is not output as the reference voltage.

On the other hand, since the second lowest bit of the gamma correction data is set at “1”, the select voltage V_{G}1 corresponding to the second lowest bit is output as the reference voltage. Therefore, the select voltage V_{G}1 is output as the reference voltage V0.

Since the third lowest bit of the gamma correction data is set at “1”, the select voltage V_{G}2 corresponding to the third lowest bit is output as the reference voltage. Therefore, the select voltage V_{G}2 is output as the reference voltage V1.

Likewise, since the second highest bit of the gamma correction data is set at “0”, the select voltage V_{G}254 corresponding to the second highest bit is not output as the reference voltage. On the other hand, since the most significant bit of the gamma correction data is set at “1”, the select voltage V_{G}255 corresponding to the most significant bit is output as the reference voltage. Therefore, the select voltage V_{G}255 is output as the reference voltage V63.

This allows the reference voltage generation circuit 54 to generate the K select voltages selected from the first to Lth select voltages arranged in potential descending order or potential ascending order as the first to Kth reference voltages arranged in potential descending order or potential ascending order.

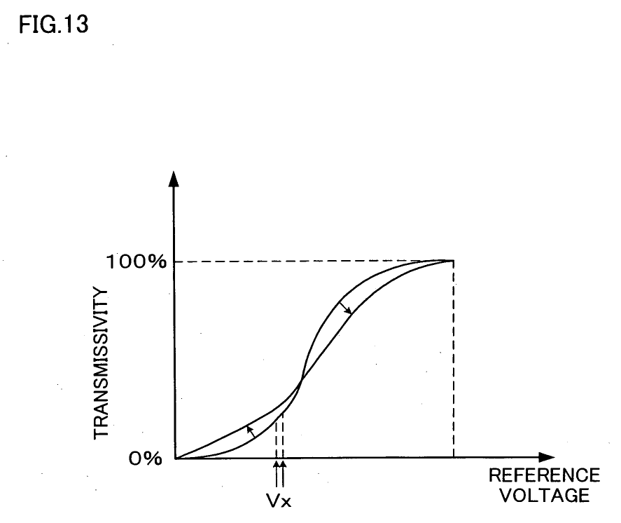

FIG. 13 is a diagram illustrative of gamma characteristics.

In FIG. 13, the horizontal axis indicates the reference voltage, and the vertical axis indicates the pixel transmissivity. As described above, one embodiment of the invention allows the voltage level of the reference voltage Vx to be selected from the select voltages so that a plurality of voltage levels can be output. Therefore, fine gamma correction corresponding to the type of LCD panel can be realized.

Moreover, the voltage levels of the reference voltages V0 to V63 output from the reference voltage generation circuit 54 can be diversified by enabling variable control of the resistance of each resistor element of the ladder resistor circuit of the select voltage generation circuit 200.

4.1 Reference Voltage Select Circuit

The reference voltage select circuit 210 according to one embodiment of the invention is described below. The reference voltage select circuit 210 outputs L select voltages selected from the K select voltages arranged in potential descending order or potential ascending order as the L reference voltages arranged in potential descending order or potential ascending order. Therefore, when implementing the function of the reference voltage select circuit 210 merely by using a circuit, the circuit scale is increased.

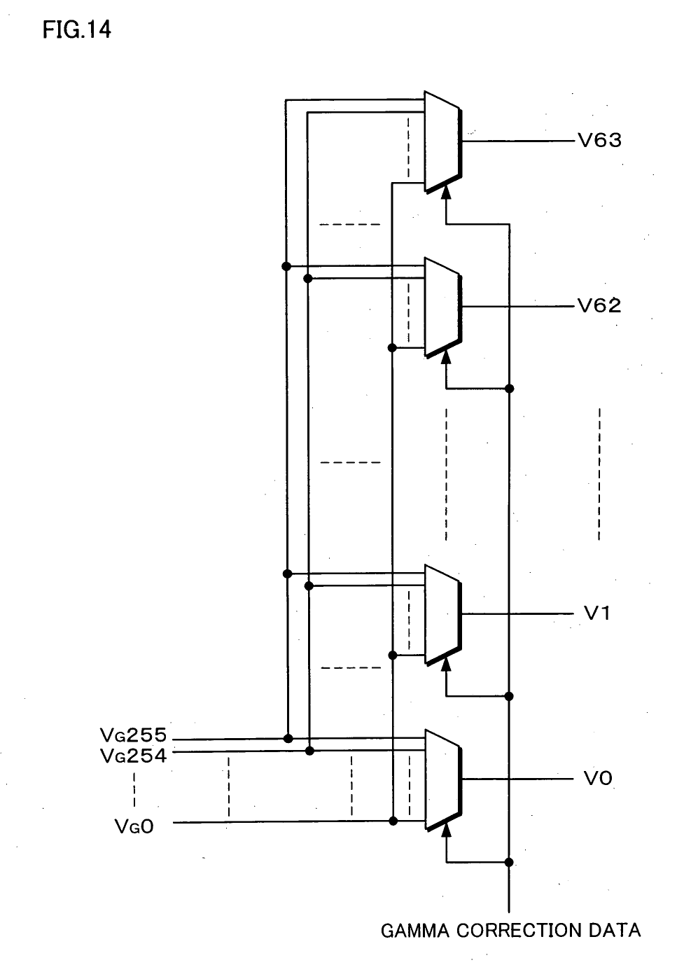

FIG. 14 is a block diagram showing a configuration example of the reference voltage select circuit 210 according to a comparative example of one embodiment of the invention.

In the comparative example, 256-input one-output selectors are provided in reference voltage units. In this case, each selector selects one of the select voltages V_{G}0 to V_{G}255 based on the gamma correction data.

Therefore, since it is necessary to add a 256-input one-output selector when the number of reference voltages is increased, the circuit scale of not only the reference voltage select circuit 210 but also the reference voltage generation circuit 54 is increased, so that power consumption is increased.

Therefore, one embodiment of the invention realizes the function of the reference voltage select circuit 210 by using a switch matrix configuration, as described below. This prevents an increase in the circuit scale of the reference voltage select circuit 210. Moreover, even if the number of select voltages and the number of reference voltages are increased, an increase in the circuit scale of the reference voltage select circuit 210 is reduced in comparison with the comparative example.

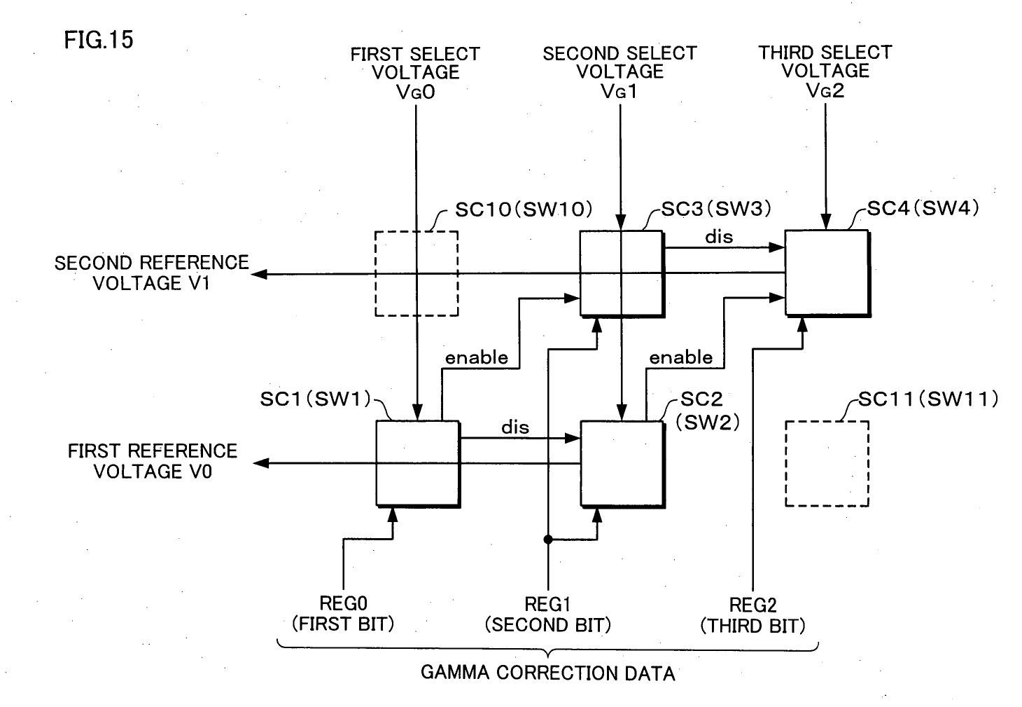

FIG. 15 is a block diagram showing a configuration example of the reference voltage select circuit 210 according to one embodiment of the invention. FIG. 15 shows an example in which the number of select voltages is three (V_{G}0, V_{G}1, V_{G}2) and the number of reference voltages is two (V0, V1) for convenience of illustration. The reference voltage select circuit 210 in which the number of select voltages is three or more and the number of reference voltages is two or more necessarily includes the configuration shown in FIG. 15. Therefore, the reference voltage generation circuit 54 according to one embodiment of the invention which generates the first to Kth reference voltages arranged in potential descending order or potential ascending order may include a reference voltage select circuit which outputs at least the first and second reference voltages of the first to Kth reference voltages as shown in FIG. 15.

The reference voltage select circuit shown in FIG. 15 selects the first and second reference voltages V0 and V1 arranged in potential descending order or potential ascending order from the first to third select voltages V_{G}0 to V_{G}2 arranged in potential descending order or potential ascending order based on the 3-bit gamma correction data.

The reference voltage select circuit includes first to fourth switch elements SW1 to SW4. The first switch element SW1 is a switch circuit for outputting the first select voltage V_{G}0 as the first reference voltage V0. The second switch element SW2 is a switch circuit for outputting the second select voltage V_{G}1 as the first reference voltage V0. The third switch element SW3 is a switch circuit for outputting the second select voltage V_{G}1 as the second reference voltage V1. The fourth switch element SW4 is a switch circuit for outputting the third select voltage V_{G}2 as the second reference voltage V1. The switch circuit electrically connects or disconnects the signal line to which the select voltage is supplied and the signal line to which the reference voltage is output.

The first switch element SW1 outputs the first select voltage V_{G}0 as the first reference voltage V0 on condition that the first switch element SW1 is enabled by the data REG0 of the first bit of the gamma correction data. The second switch element SW2 outputs the second select voltage V_{G}1 as the first reference voltage V0 on condition that the second switch element SW2 is disabled by the data REG0 of the first bit of the gamma correction data and enabled by the data REG1 of the second bit of the gamma correction data. The third switch element SW3 outputs the second select voltage V_{G}1 as the second reference voltage V1 on condition that the third switch element SW3 is enabled by the data REG0 of the first bit of the gamma correction data and enabled by the data REG1 of the second bit of the gamma correction data. The fourth switch element SW4 outputs the third select voltage V_{G}2 as the second reference voltage V1 on condition that the fourth switch element SW4 is enabled by the data REG0 of the first bit of the gamma correction data, disabled by the data REG1 of the second bit of the gamma correction data, and enabled by the data REG2 of the third bit of the gamma correction data.

The reference voltage select circuit shown in FIG. 15 may include first to fourth switch cells SC1 to SC4 respectively including the first to fourth switch elements SW1 to SW4. Each switch cell ON/OFF-controls the switch element provided therein based on the enable signal and the disable signal supplied from other switch cells, and outputs the enable signal and the disable signal to other switch cells.

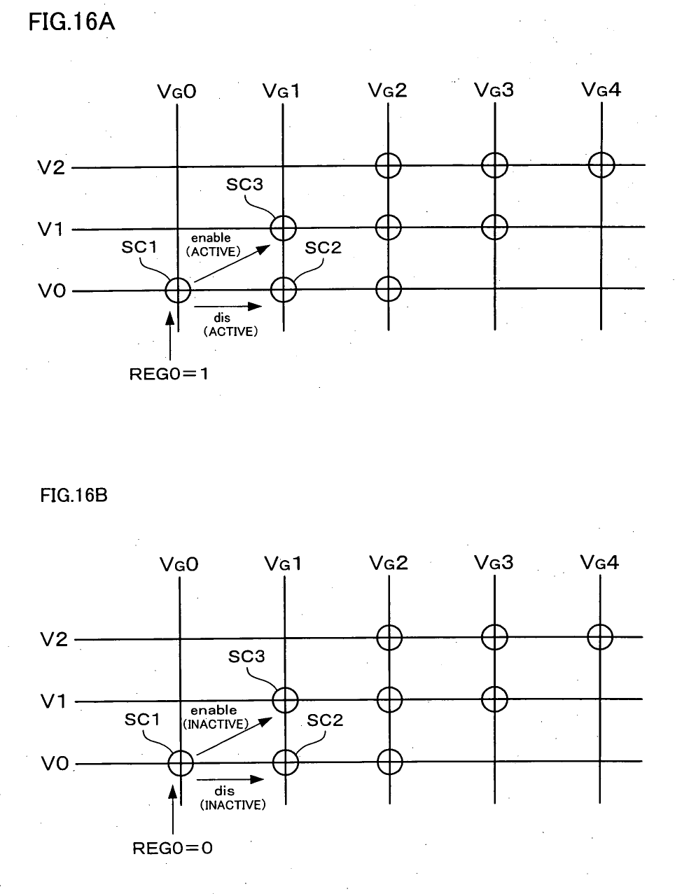

FIGS. 16A and 16B are diagrams illustrative of the enable signal and the disable signal output from one switch cell to other switch cells. FIGS. 16A and 16B show an example in which three reference voltages are selected from four select voltages.

In FIG. 16A, when the first switch cell SC1 is enabled by the data REG0 of the first bit of the gamma correction data, the first switch cell SC1 activates the disable signal “dis” to the second switch cell SC2 and activates the enable signal “enable” to the third switch cell, for example.

The second switch cell SC2 ON/OFF-controls the second switch element SW2 included in the second switch cell SC2 by using the disable signal “dis” from the first switch cell SC1. Likewise, the third switch cell SC3 ON/OFF-controls the third switch element SW3 included in the third switch cell SC3 by using the enable signal “enable” from the first switch cell SC1.

In FIG. 16B, when the first switch cell SC1 is disabled by the data REG0 of the first bit of the gamma correction data, the first switch cell SC1 deactivates the disable signal “dis” to the second switch cell SC2 and deactivates the enable signal “enable” to the third switch cell SC3, for example.

In this case, the second switch cell SC2 ON/OFF-controls the second switch element SW2 included in the second switch cell SC2 by using the disable signal “dis” from the first switch cell SC1 in the same manner as in FIG. 16A. The third switch cell SC3 ON/OFF-controls the third switch element SW3 included in the third switch cell SC3 by using the enable signal “enable” from the first switch cell SC1.

In more detail, when the first switch cell SC1 is enabled by the data REG0 of the first bit of the gamma correction data, the first switch cell SC1 activates the disable signal “dis” to the second switch cell SC2 and activates the enable signal “enable” to the third switch cell SC3. When the first switch cell SC1 is disabled by the data REG0 of the first bit of the gamma correction data, the first switch cell SC1 deactivates the disable signal “dis” to the second switch cell SC2 and deactivates the enable signal “enable” to the third switch cell SC3.

The second switch cell SC2 outputs the second select voltage V_{G}1 as the first reference voltage V0 and activates the enable signal “enable” to the fourth switch cell SC4 on condition that the second switch cell SC2 is enabled by the data REG1 of the second bit of the gamma correction data and the disable signal “dis” from the first switch cell SC1 is inactive. Otherwise the second switch cell SC2 deactivates the enable signal “enable” to the fourth switch cell SC4.

The third switch cell SC3 outputs the second select voltage V_{G}1 as the second reference voltage V1 and activates the disable signal “dis” to the fourth switch cell SC4 on condition that the third switch cell SC3 is enabled by the data REG1 of the second bit of the gamma correction data and the enable signal “enable” from the first switch cell SC1 is active. Otherwise the third switch cell SC3 deactivates the disable signal “dis” to the fourth switch cell SC4.

The fourth switch cell SC4 outputs the third select voltage V_{G}2 as the second reference voltage V1 on condition that the fourth switch cell SC4 is enabled by the data REG2 of the third bit of the gamma correction data, the disable signal “dis” from the third switch cell SC3 is inactive, and the enable signal “enable” from the second switch cell SC2 is active.

It suffices to connect similar switch cells by propagating the enable signal and the disable signal as described above, so that the design and design change of the reference voltage select circuit are facilitated. Note that the disable signal may be propagated as the enable signal.

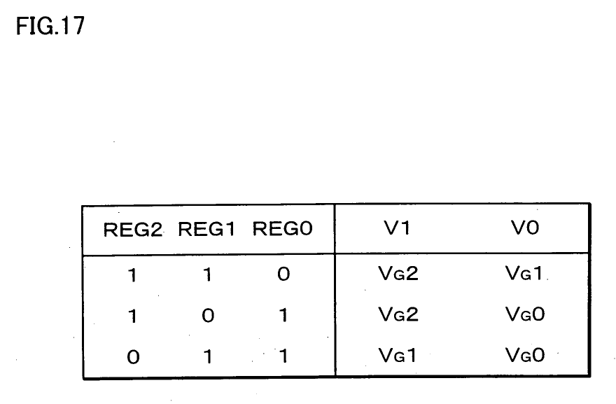

FIG. 17 shows an operation example of the reference voltage select circuit shown in FIG. 15.

As shown in FIG. 17, the reference voltage select circuit shown in FIG. 15 outputs the first and second reference voltages V0 and V1 arranged in potential descending order or potential ascending order from the first to third select voltages V_{G}0 to V_{G}2 arranged in potential descending order or potential ascending order based on the data of bits of the 3-bit gamma correction data set at “1”.

By propagating the signals (enable signal and disable signal) as described above by using the switch elements or the switch cells including the switch elements, the number of switch elements or switch cells can be reduced even when realizing the reference voltage select circuit by using a switch matrix configuration.

In general, when realizing a circuit which selects the first and second reference voltages V0 and V1 from the first to third select voltages V_{G}1 to V_{G}2 by using a switch matrix configuration, it is necessary to provide six (=3×2) switch elements or switch cells.

However, the third select voltage V_{G}2 is not output as the first reference voltage V0 taking into consideration the characteristics in which two reference voltages are output in potential descending order or potential ascending order. Likewise, the first select voltage V_{G}0 is not output as the second reference voltage V1. Therefore, the switch element SW10 (switch cell SC10 including the switch element SW10) and the switch element SW11 (switch cell SC11 including the switch element SW11) can be omitted in FIG. 15.

In one embodiment of the invention, the reference voltage select circuit selects the first to Kth reference voltages arranged in potential descending order or potential ascending order from the first to Lth select voltages arranged in potential descending order or potential ascending order. Therefore, in one embodiment of the invention, (L−K+1) switch cells are necessary for outputting one reference voltage. Therefore, the reference voltage select circuit can be realized by using K×(L−K+1) switch cells.

A specific circuit configuration example of the reference voltage select circuit according to one embodiment of the invention is described below.

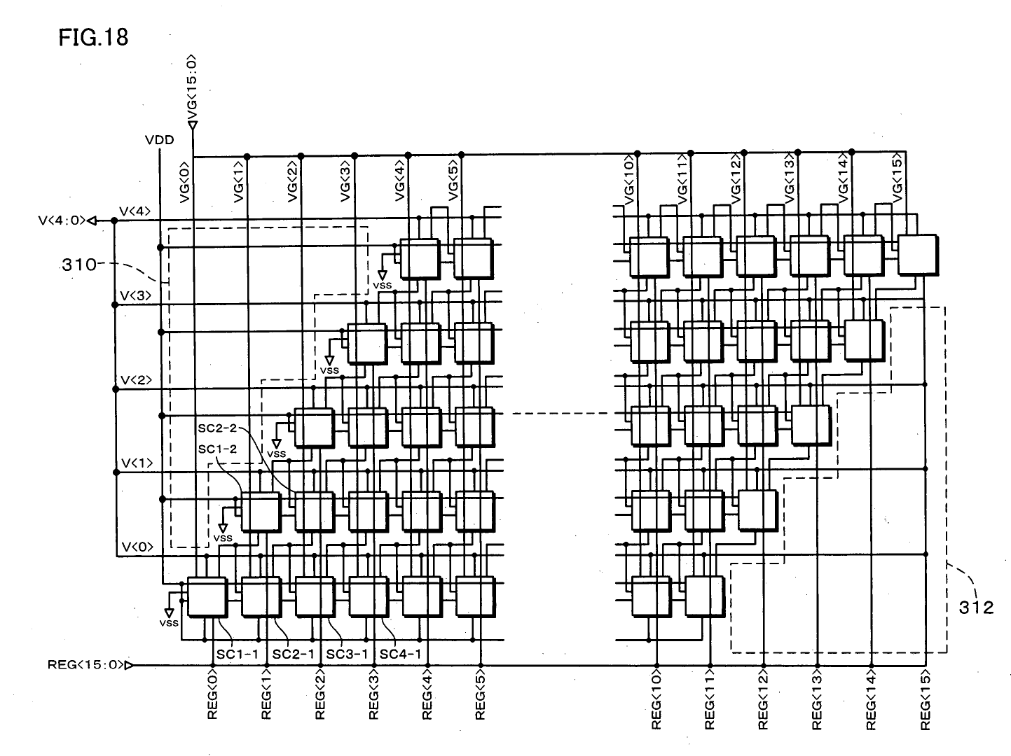

FIG. 18 shows a specific circuit configuration example of the reference voltage select circuit according to one embodiment of the invention. FIG. 18 shows a configuration example in which L is sixteen (first to sixteenth select voltages V_{G}0 to V_{G}15) and K is five (first to fourth reference voltages V0 to V4).

VG<15:0> indicates the first to sixteenth select voltages V_{G}0 to V_{G}15. Each select voltage is supplied to the signal line for each bit of VG<15:0>. V<4:0> indicates the first to fourth reference voltages V0 to V4. Each reference voltage is supplied to the signal line for each bit of V<4:0>. REG<15:0> indicates the 16-bit gamma correction data.

While 80 (=5×16) switch cells are necessary when simply employing a switch matrix configuration, the reference voltage select circuit according to one embodiment of the invention can be realized by using 60 (=5×(16−5+1)) switch cells. This is because the switch cells in circuit sections 310 and 312 shown in FIG. 18 can be omitted for the above-described reason.

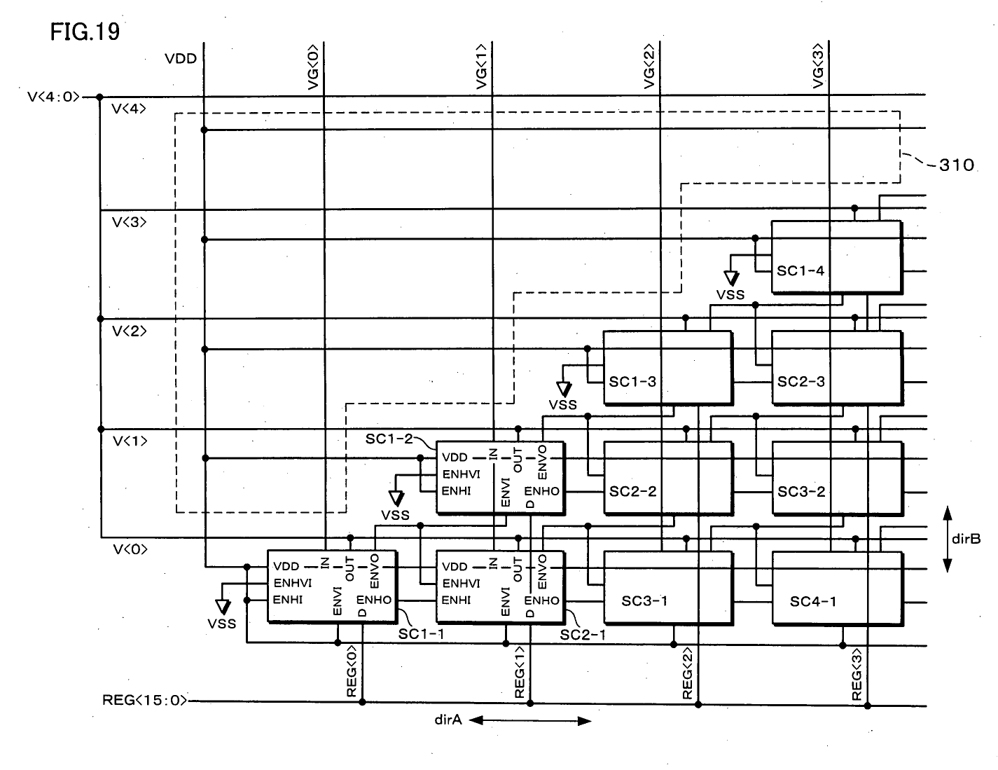

FIG. 19 is an enlarged diagram of a part of the circuit diagram shown in FIG. 18.

In FIG. 19, sections the same as the sections shown in FIG. 18 are indicated by the same symbols. Description of these sections is appropriately omitted. In FIG. 19, switch cells SC1-1, SC2-1, SC3-1, SC4-1, . . . , SC2-1, SC2-2, . . . have the same configuration.

Each switch cell includes a VDD terminal, an ENHVI terminal, an ENHI terminal, an ENVI terminal, a D terminal, an ENHO terminal, an ENVO terminal, an OUT terminal, and an IN terminal.

The VDD terminal is a terminal to which the high-potential-side power supply voltage VDD is supplied. In the switch cell, illustration of a terminal to which the low-potential-side power supply voltage VSS is supplied is omitted. The ENHVI terminal is a terminal to which the enable signal “enable” supplied to the cells arranged in a direction dirB is input. The ENHI terminal is a terminal to which the enable signal “enable” supplied to the cells arranged in a direction dirA (equivalent to the disable signal “dis” of which the logic level is reversed) is input. The ENVI terminal is a terminal to which the enable signal “enable” supplied to the cells arranged in the direction dirB is input. The ENHO terminal is a terminal from which the enable signal “enable” supplied to the cells arranged in the direction dirA (equivalent to the disable signal “dis” of which the logic level is reversed) is output. The D terminal is a terminal to which the data of each bit of the gamma correction data is input. The ENVO terminal is a terminal from which the enable signal “enable” supplied to the cells arranged in the direction dirB is output. The OUT terminal is a terminal from which the reference voltage is supplied. The IN terminal is a terminal to which the select voltage is supplied.

Therefore, the reference voltage select circuit may include the first to fourth switch cells SC1-1, SC2-1, SC1-2, and SC2-2, as shown in FIG. 19. The first switch cell SC1-1 includes a first switch element for outputting the first select voltage of the first to third select voltages arranged in potential descending order or potential ascending order as the first reference voltage of the first and second reference voltages arranged in potential descending order or potential ascending order. The second switch cell SC2-1 includes a second switch element for outputting the second select voltage as the first reference voltage. The third switch cell SC1-2 includes a third switch element for outputting the second select voltage as the second reference voltage. The fourth switch cell SC2-2 includes a fourth switch element for outputting the third select voltage as the second reference voltage.

The data of the first bit of the L-bit gamma correction data, the data of each bit of the gamma correction data being associated with one of the select voltages and indicating whether or not to output the select voltage as the reference voltage, is supplied to the first switch cell SC1-1, and the first switch cell SC1-1 outputs the enable signal to the second and third switch cells SC2-1 and SC1-2. The data of the second bit of the gamma correction data is supplied to the second switch cell SC2-1, and the second switch cell SC2-1 outputs the enable signal to the third and fourth switch cells SC1-2 and SC2-2. The data of the second bit of the gamma correction data is supplied to the third switch cell SC1-2, and the third switch cell SC1-2 outputs the enable signal to the fourth switch cell SC2-2. The data of the third bit of the gamma correction data is supplied to the fourth switch cell SC2-2.

In FIG. 19, the disable signal “dis” is output as the enable signal “enable”. This is because the enable signal “enable” set to active is equivalent to the disable signal “dis” set to inactive and the enable signal “enable” set to inactive is equivalent to the disable signal “dis” set to active.

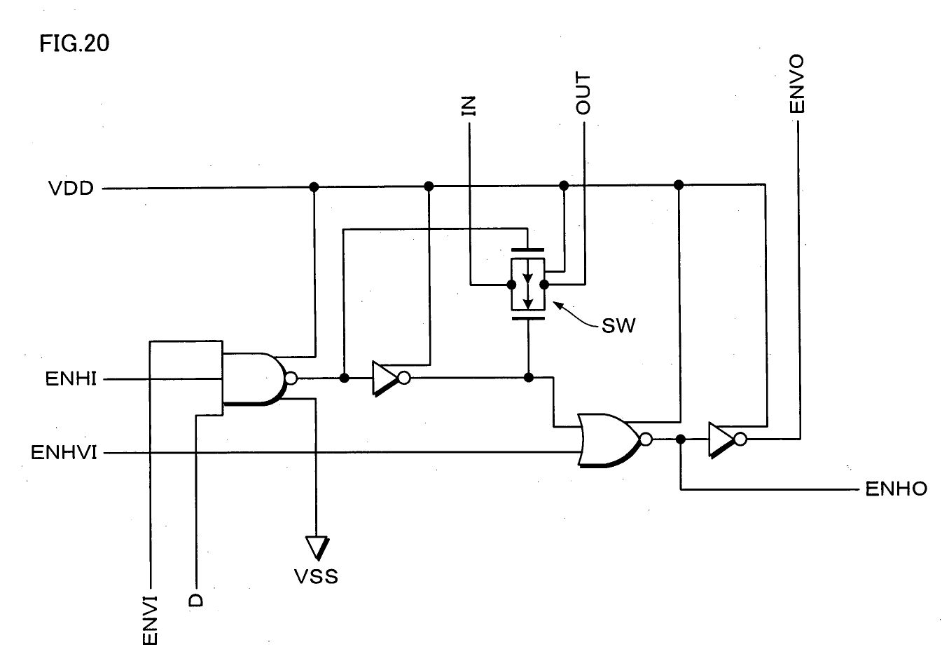

FIG. 20 shows a circuit configuration example of the switch cell shown in FIG. 19.

In FIG. 20, the switch element SW is formed by using a transfer gate. When the AND result of the signals input through the ENVI terminal, the D terminal, and the ENHI terminal is “H”, the switch element SW is set in a conducting state so that the IN terminal and the OUT terminal are set at the same potential. When the AND result is “L”, the switch element SW is set in a nonconducting state.

The OR result of the AND result and the signal input through the ENHVI terminal is output from the ENVO terminal. The inversion result of the OR result of the AND result and the signal input through the ENHVI terminal is output from the ENHO terminal.

4.2 Modification

The gamma correction data setting circuit 222 according to one embodiment of the invention sets the parallel data in the gamma correction data register 220 in synchronization with the shift output of the shift register. However, the invention is not limited thereto.

A gamma correction data setting circuit 400 according to a modification of one embodiment of the invention sets the above-mentioned parallel data in the gamma correction data register based on an address designating the write area of the gamma correction data register.

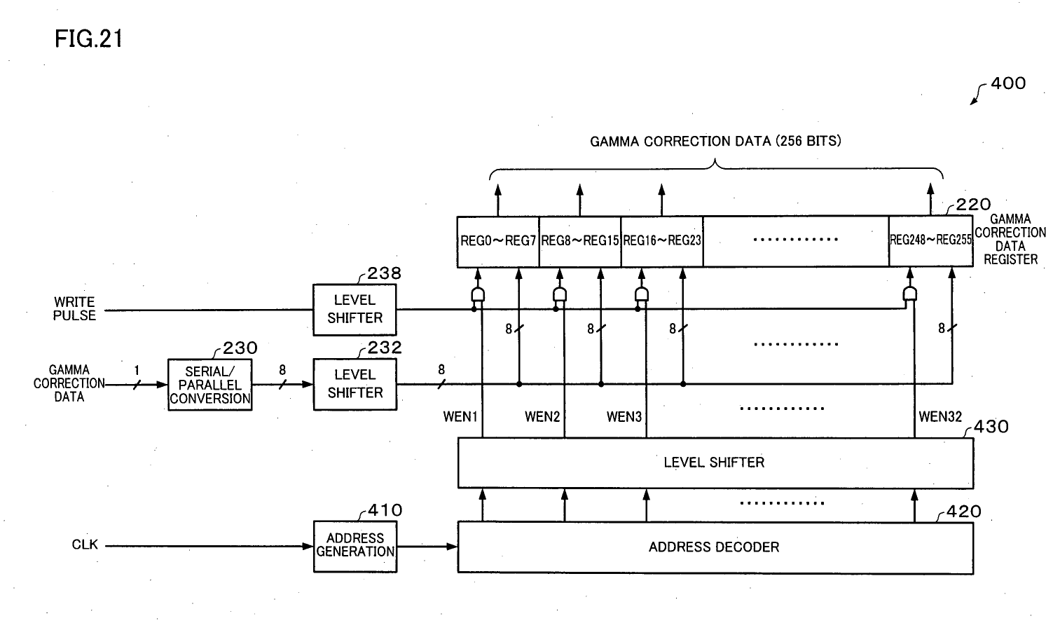

FIG. 21 is a block diagram of a configuration example of the gamma correction data setting circuit 400 according to the modification of one embodiment of the invention. In FIG. 21, sections the same as the sections shown in FIG. 10 are indicated by the same symbols. Description of these sections is appropriately omitted.

The reference voltage generation circuit 54 may include the gamma correction data setting circuit 400 according to this modification instead of the gamma correction data setting circuit 222 shown in FIG. 8.

The gamma correction data setting circuit 400 includes an address generation circuit 410, and sets the gamma correction data of which the signal level has been converted by the level shifter 232 in the gamma correction data register 220 based on the address generated by the address generation circuit 410. The function of the address generation circuit 410 may be realized by using a counter which counts the clock signal CLK as the input synchronization clock signal for the data of each bit of the gamma correction data.

The gamma correction data setting circuit 400 may include an address decoder 420 and a level shifter 430. The address decoder 420 decodes the address generated by the address generation circuit 410, and determines whether the write area indicated by the address is the area of the data REG0 to REG7, REG8 to REG15, . . . , or REG248 to REG255 of the bits of the gamma correction data. The decode result of the address decoder 420 is converted in signal level by the level shifter 430, and output as write enable signals WEN1 to WEN32.

For example, the clock signal CLK is counted, and only the write enable signal WEN1 is set to active when the count value is 1 to 8 for designating the write area of the data REG0 to REG7 of the bits of the gamma correction data. When the count value is 17 to 24, only the write enable signal WEN3 is set to active for designating the write area of the data REG16 to REG23 of the bits of the gamma correction data.

The write enable signals WEN1 to WEN32 are mask-controlled by the output of the level shifter 238.

According to this modification, it suffices to write the gamma correction data in the gamma correction data register 220 at low speed in synchronization with 32 write pulses instead of writing the gamma correction data in the gamma correction data register 220 at high speed in synchronization with 256 write pulses in the same manner as in one embodiment of the invention, for example. This significantly reduces power consumption required to set the gamma correction data.

5. Electronic Instrument

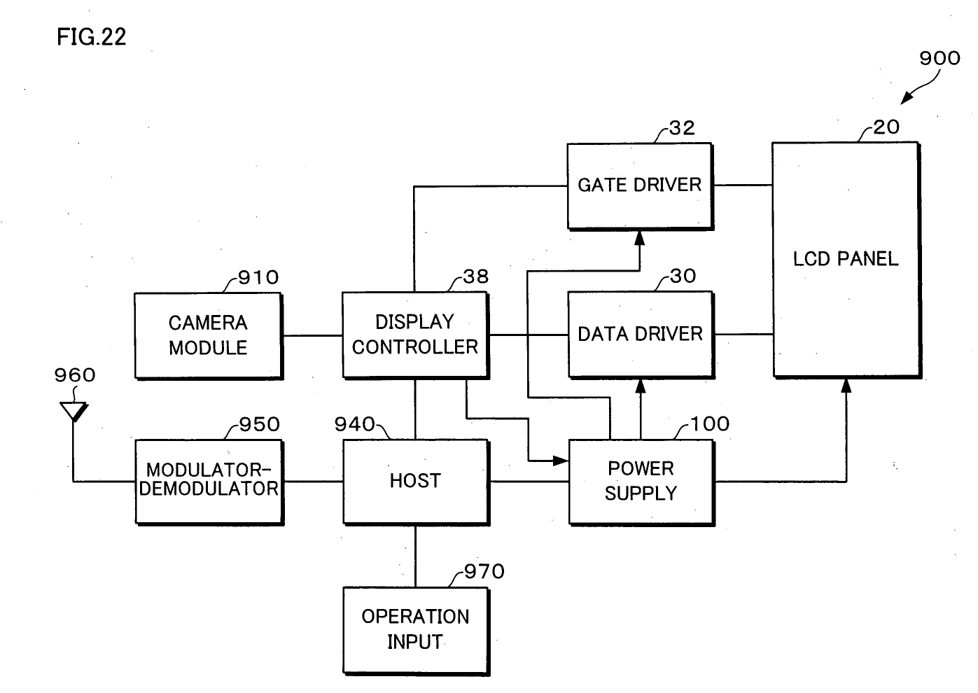

FIG. 22 is a block diagram showing a configuration example of an electronic instrument according to one embodiment of the invention: FIG. 22 is a block diagram showing a configuration example of a portable telephone as an example of the electronic instrument. In FIG. 22, sections the same as the sections shown in FIG. 1 or 2 are indicated by the same symbols. Description of these sections is appropriately omitted.

A portable telephone 900 includes a camera module 910. The camera module 910 includes a CCD camera, and supplies data of an image captured by using the CCD camera to the display controller 38 in a YUV format.

The portable telephone 900 includes the LCD panel 20. The LCD panel 20 is driven by the data driver 30 and the gate driver 32. The LCD panel 20 includes gate lines, source lines, and pixels.

The display controller 38 is connected with the data driver 30 and the gate driver 32, and supplies display data in an RGB format to the data driver 30.

The power supply circuit 100 is connected with the data driver 30 and the gate driver 32, and supplies drive power supply voltages to the data driver 30 and the gate driver 32. The power supply circuit 100 supplies the common electrode voltage Vcom to the common electrode of the LCD panel 20.

A host 940 is connected with the display controller 38. The host 940 controls the display controller 38. The host 940 demodulates display data received through an antenna 960 by using a modulator-demodulator section 950, and supplies the demodulated display data to the display controller 38. The display controller 38 causes the data driver 30 and the gate driver 32 to display an image in the LCD panel 20 based on the display data.

The host 940 modulates display data generated by the camera module 910 by using the modulator-demodulator section 950, and directs transmission of the modulated data to another communication device through the antenna 960.

The host 940 transmits and receives display data, images using the camera module 910, and displays on the LCD panel 20 based on operational information from an operation input section 970.

The invention is not limited to the above-described embodiments. Various modifications and variations may be made within the spirit and scope of the invention. For example, the invention may be applied not only to drive the above-described liquid crystal display panel, but also to drive an electroluminescent or plasma display device.

The above-described embodiment illustrates an example in which the gamma correction data is read from the EEPROM. However, the invention is not limited thereto. The gamma correction data may be read from the host or an external circuit such as the display controller.

Part of requirements of any claim of the present invention could be omitted from a dependent claim which depends on that claim. Moreover, part of requirements of any independent claim of the present invention could be made to depend on any other independent claim.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A reference voltage generation circuit which generates a plurality of reference voltages for performing gamma correction, the reference voltage generation circuit comprising:
a serial/parallel conversion circuit which converts serially input gamma correction data into parallel data of a given number of bits;
a level shifter which converts a signal level of each bit of the parallel data;
a gamma correction data register in which the gamma correction data of which the signal level has been converted by the level shifter is set in units of the number of bits; and
a reference voltage select circuit which outputs K kinds of select voltages selected from first to Lth (L is an integer larger than two) select voltages arranged in potential descending order or potential ascending order based on the gamma correction data set in the gamma correction data register as first to Kth (K is a natural number smaller than L) reference voltages in potential descending order or potential ascending order.

2. The reference voltage generation circuit as defined in claim 1, comprising:
a shift register including a plurality of flip-flops connected in series and performing a shift operation in synchronization with a clock signal to output shift outputs in units of the number of bits;
wherein the data of each bit of the gamma correction data is input in synchronization with the clock signal; and
wherein the gamma correction data of which the signal level has been converted by the level shifter is set in the gamma correction data register based on the shift outputs output in units of the number of bits.

3. The reference voltage generation circuit as defined in claim 1, comprising:
an address generation circuit which generates an address for designating a write area of the gamma correction data register;
wherein the gamma correction data of which the signal level has been converted by the level shifter is set in the gamma correction data register based on the address generated by the address generation circuit.

4. The reference voltage generation circuit as defined in claim 1, comprising:
first to Kth impedance conversion circuits to which the K kinds of select voltages selected by the reference voltage select circuit are respectively supplied at an input of each impedance conversion circuit;
wherein outputs of the first to Kth impedance conversion circuits are output as the first to Kth reference voltages.

5. The reference voltage generation circuit as defined in claim 2, comprising:
first to Kth impedance conversion circuits to which the K kinds of select voltages selected by the reference voltage select circuit are respectively supplied at an input of each impedance conversion circuit;
wherein outputs of the first to Kth impedance conversion circuits are output as the first to Kth reference voltages.

6. The reference voltage generation circuit as defined in claim 3, comprising:
first to Kth impedance conversion circuits to which the K kinds of select voltages selected by the reference voltage select circuit are respectively supplied at an input of each impedance conversion circuit;
wherein outputs of the first to Kth impedance conversion circuits are output as the first to Kth reference voltages.

7. The reference voltage generation circuit as defined in claim 1,
wherein the gamma correction data is L-bit data, the data of each bit of the L-bit data being associated with one of the select voltages and indicating whether or not to output the one of the select voltages as one of the reference voltages.

8. The reference voltage generation circuit as defined in claim 2,
wherein the gamma correction data is L-bit data, the data of each bit of the L-bit data being associated with one of the select voltages and indicating whether or not to output the one of the select voltages as one of the reference voltages.

9. The reference voltage generation circuit as defined in claim 3,
wherein the gamma correction data is L-bit data, the data of each bit of the L-bit data being associated with one of the select voltages and indicating whether or not to output the one of the select voltages as one of the reference voltages.

10. The reference voltage generation circuit as defined in claim 1,
wherein the reference voltage select circuit includes:
a first switch element for outputting the first select voltage as the first reference voltage;
a second switch element for outputting the second select voltage as the first reference voltage;
a third switch element for outputting the second select voltage as the second reference voltage; and
a fourth switch element for outputting the third select voltage as the second reference voltage;
wherein the first switch element outputs the first select voltage as the first reference voltage on condition that the first switch element is enabled by the data of the first bit of the gamma correction data;
wherein the second switch element outputs the second select voltage as the first reference voltage on condition that the second switch element is disabled by the data of the first bit of the gamma correction data and enabled by the data of the second bit of the gamma correction data;
wherein the third switch element outputs the second select voltage as the second reference voltage on condition that the third switch element is enabled by the data of the first bit of the gamma correction data and enabled by the data of the second bit of the gamma correction data;
wherein the fourth switch element outputs the third select voltage as the second reference voltage on condition that the fourth switch element is enabled by the data of the first bit of the gamma correction data, disabled by the data of the second bit of the gamma correction data, and enabled by the data of the third bit of the gamma correction data; and
wherein the reference voltage select circuit outputs at least the first and second reference voltages of the first to Kth reference voltages.

11. The reference voltage generation circuit as defined in claim 2,
wherein the reference voltage select circuit includes:
a first switch element for outputting the first select voltage as the first reference voltage;
a second switch element for outputting the second select voltage as the first reference voltage;
a third switch element for outputting the second select voltage as the second reference voltage; and
a fourth switch element for outputting the third select voltage as the second reference voltage;
wherein the first switch element outputs the first select voltage as the first reference voltage on condition that the first switch element is enabled by the data of the first bit of the gamma correction data;
wherein the second switch element outputs the second select voltage as the first reference voltage on condition that the second switch element is disabled by the data of the first bit of the gamma correction data and enabled by the data of the second bit of the gamma correction data;
wherein the third switch element outputs the second select voltage as the second reference voltage on condition that the third switch element is enabled by the data of the first bit of the gamma correction data and enabled by the data of the second bit of the gamma correction data;
wherein the fourth switch element outputs the third select voltage as the second reference voltage on condition that the fourth switch element is enabled by the data of the first bit of the gamma correction data, disabled by the data of the second bit of the gamma correction data, and enabled by the data of the third bit of the gamma correction data; and
wherein the reference voltage select circuit outputs at least the first and second reference voltages of the first to Kth reference voltages.

12. The reference voltage generation circuit as defined in claim 3,
wherein the reference voltage select circuit includes:
a first switch element for outputting the first select voltage as the first reference voltage;
a second switch element for outputting the second select voltage as the first reference voltage;
a third switch element for outputting the second select voltage as the second reference voltage; and
a fourth switch element for outputting the third select voltage as the second reference voltage;
wherein the first switch element outputs the first select voltage as the first reference voltage on condition that the first switch element is enabled by the data of the first bit of the gamma correction data;
wherein the second switch element outputs the second select voltage as the first reference voltage on condition that the second switch element is disabled by the data of the first bit of the gamma correction data and enabled by the data of the second bit of the gamma correction data;
wherein the third switch element outputs the second select voltage as the second reference voltage on condition that the third switch element is enabled by the data of the first bit of the gamma correction data and enabled by the data of the second bit of the gamma correction data;
wherein the fourth switch element outputs the third select voltage as the second reference voltage on condition that the fourth switch element is enabled by the data of the first bit of the gamma correction data, disabled by the data of the second bit of the gamma correction data, and enabled by the data of the third bit of the gamma correction data; and
wherein the reference voltage select circuit outputs at least the first and second reference voltages of the first to Kth reference voltages.

13. The reference voltage generation circuit as defined in claim 10, comprising:
first to fourth switch cells respectively including the first to fourth switch elements;
wherein the first switch cell activates a disable signal to the second switch cell and activates an enable signal to the third switch cell when the first switch cell is enabled by the data of the first bit of the gamma correction data, and deactivates the disable signal to the second switch cell and deactivates the enable signal to the third switch cell when the first switch cell is disabled by the data of the first bit of the gamma correction data;
wherein the second switch cell outputs the second select voltage as the first reference voltage and activates the enable signal to the fourth switch cell on condition that the second switch cell is enabled by the data of the second bit of the gamma correction data and the disable signal from the first switch cell is inactive, and the second switch cell deactivates the enable signal to the fourth switch cell in other cases;
wherein the third switch cell outputs the second select voltage as the second reference voltage and activates the disable signal to the fourth switch cell on condition that the third switch cell is enabled by the data of the second bit of the gamma correction data and the enable signal from the first switch cell is active, and the third switch cell deactivates the disable signal to the fourth switch cell in other cases; and
wherein the fourth switch cell outputs the third select voltage as the second reference voltage on condition that the fourth switch cell is enabled by the data of the third bit of the gamma correction data, the disable signal from the third switch cell is inactive, and the enable signal from the second switch cell is active.

14. The reference voltage generation circuit as defined in claim 11, comprising:
first to fourth switch cells respectively including the first to fourth switch elements;
wherein the first switch cell activates a disable signal to the second switch cell and activates an enable signal to the third switch cell when the first switch cell is enabled by the data of the first bit of the gamma correction data, and deactivates the disable signal to the second switch cell and deactivates the enable signal to the third switch cell when the first switch cell is disabled by the data of the first bit of the gamma correction data;
wherein the second switch cell outputs the second select voltage as the first reference voltage and activates the enable signal to the fourth switch cell on condition that the second switch cell is enabled by the data of the second bit of the gamma correction data and the disable signal from the first switch cell is inactive, and the second switch cell deactivates the enable signal to the fourth switch cell in other cases;
wherein the third switch cell outputs the second select voltage as the second reference voltage and activates the disable signal to the fourth switch cell on condition that the third switch cell is enabled by the data of the second bit of the gamma correction data and the enable signal from the first switch cell is active, and the third switch cell deactivates the disable signal to the fourth switch cell in other cases; and
wherein the fourth switch cell outputs the third select voltage as the second reference voltage on condition that the fourth switch cell is enabled by the data of the third bit of the gamma correction data, the disable signal from the third switch cell is inactive, and the enable signal from the second switch cell is active.

15. The reference voltage generation circuit as defined in claim 12, comprising:
first to fourth switch cells respectively including the first to fourth switch elements;
wherein the first switch cell activates a disable signal to the second switch cell and activates an enable signal to the third switch cell when the first switch cell is enabled by the data of the first bit of the gamma correction data, and deactivates the disable signal to the second switch cell and deactivates the enable signal to the third switch cell when the first switch cell is disabled by the data of the first bit of the gamma correction data;
wherein the second switch cell outputs the second select voltage as the first reference voltage and activates the enable signal to the fourth switch cell on condition that the second switch cell is enabled by the data of the second bit of the gamma correction data and the disable signal from the first switch cell is inactive, and the second switch cell deactivates the enable signal to the fourth switch cell in other cases;
wherein the third switch cell outputs the second select voltage as the second reference voltage and activates the disable signal to the fourth switch cell on condition that the third switch cell is enabled by the data of the second bit of the gamma correction data and the enable signal from the first switch cell is active, and the third switch cell deactivates the disable signal to the fourth switch cell in other cases; and
wherein the fourth switch cell outputs the third select voltage as the second reference voltage on condition that the fourth switch cell is enabled by the data of the third bit of the gamma correction data, the disable signal from the third switch cell is inactive, and the enable signal from the second switch cell is active.

16. The reference voltage generation circuit as defined in claim 1,
wherein the reference voltage select circuit includes:
a first switch cell including a first switch element for outputting the first select voltage as the first reference voltage;
a second switch cell including a second switch element for outputting the second select voltage as the first reference voltage;
a third switch cell including a third switch element for outputting the second select voltage as the second reference voltage; and
a fourth switch cell including a fourth switch element for outputting the third select voltage as the second reference voltage;
wherein the first switch cell is provided with the data of the first bit of the gamma correction data and outputs an enable signal to the second and third switch cells;
wherein the second switch cell is provided with the data of the second bit of the gamma correction data and outputs the enable signal to the third and fourth switch cells;
wherein the third switch cell is provided with the data of the second bit of the gamma correction data and outputs the enable signal to the fourth switch cell;
wherein the fourth switch cell is provided with the data of the third bit of the gamma correction data; and
wherein the reference voltage select circuit outputs at least the first and second reference voltages of the first to Kth reference voltages.

17. The reference voltage generation circuit as defined in claim 2,
wherein the reference voltage select circuit includes:
a first switch cell including a first switch element for outputting the first select voltage as the first reference voltage;
a second switch cell including a second switch element for outputting the second select voltage as the first reference voltage;
a third switch cell including a third switch element for outputting the second select voltage as the second reference voltage; and
a fourth switch cell including a fourth switch element for outputting the third select voltage as the second reference voltage;
wherein the first switch cell is provided with the data of the first bit of the gamma correction data and outputs an enable signal to the second and third switch cells;
wherein the second switch cell is provided with the data of the second bit of the gamma correction data and outputs the enable signal to the third and fourth switch cells;
wherein the third switch cell is provided with the data of the second bit of the gamma correction data and outputs the enable signal to the fourth switch cell;
wherein the fourth switch cell is provided with the data of the third bit of the gamma correction data; and
wherein the reference voltage select circuit outputs at least the first and second reference voltages of the first to Kth reference voltages.

18. The reference voltage generation circuit as defined in claim 3,
wherein the reference voltage select circuit includes:
a first switch cell including a first switch element for outputting the first select voltage as the first reference voltage;
a second switch cell including a second switch element for outputting the second select voltage as the first reference voltage;
a third switch cell including a third switch element for outputting the second select voltage as the second reference voltage; and
a fourth switch cell including a fourth switch element for outputting the third select voltage as the second reference voltage;
wherein the first switch cell is provided with the data of the first bit of the gamma correction data and outputs an enable signal to the second and third switch cells;
wherein the second switch cell is provided with the data of the second bit of the gamma correction data and outputs the enable signal to the third and fourth switch cells;
wherein the third switch cell is provided with the data of the second bit of the gamma correction data and outputs the enable signal to the fourth switch cell;
wherein the fourth switch cell is provided with the data of the third bit of the gamma correction data; and
wherein the reference voltage select circuit outputs at least the first and second reference voltages of the first to Kth reference voltages.

19. A display driver for driving data lines of an electro-optical device, the display driver comprising:
the reference voltage generation circuit as defined in claim 1;
a voltage select circuit which selects a reference voltage corresponding to grayscale data from the first to Kth reference voltages from the reference voltage generation circuit, and outputs the selected reference voltage as a data voltage; and
a driver circuit which drives the data line based on the data voltage.

20. A display driver for driving data lines of an electro-optical device, the display driver comprising:
the reference voltage generation circuit as defined in claim 2;
a voltage select circuit which selects a reference voltage corresponding to grayscale data from the first to Kth reference voltages from the reference voltage generation circuit, and outputs the selected reference voltage as a data voltage; and
a driver circuit which drives the data line based on the data voltage.

21. A display driver for driving data lines of an electro-optical device, the display driver comprising:
the reference voltage generation circuit as defined in claim 3;
a voltage select circuit which selects a reference voltage corresponding to grayscale data from the first to Kth reference voltages from the reference voltage generation circuit, and outputs the selected reference voltage as a data voltage; and
a driver circuit which drives the data line based on the data voltage.

22. A display driver for driving data lines of an electro-optical device, the display driver comprising:
the reference voltage generation circuit as defined in claim 10;
a voltage select circuit which selects a reference voltage corresponding to grayscale data from the first to Kth reference voltages from the reference voltage generation circuit, and outputs the selected reference voltage as a data voltage; and
a driver circuit which drives the data line based on the data voltage.

23. A display driver for driving data lines of an electro-optical device, the display driver comprising:
the reference voltage generation circuit as defined in claim 11;
a voltage select circuit which selects a reference voltage corresponding to grayscale data from the first to Kth reference voltages from the reference voltage generation circuit, and outputs the selected reference voltage as a data voltage; and
a driver circuit which drives the data line based on the data voltage.

24. A display driver for driving data lines of an electro-optical device, the display driver comprising:
the reference voltage generation circuit as defined in claim 12;
a voltage select circuit which selects a reference voltage corresponding to grayscale data from the first to Kth reference voltages from the reference voltage generation circuit, and outputs the selected reference voltage as a data voltage; and
a driver circuit which drives the data line based on the data voltage.

25. An electro-optical device comprising:
a plurality of scan lines;
a plurality of data lines;
a pixel electrode specified by one of the scan lines and one of the data lines;
a scan driver which scans the scan lines; and
the display driver as defined in claim 19 which drives the data lines.

26. An electro-optical device comprising:
a plurality of scan lines;
a plurality of data lines;
a pixel electrode specified by one of the scan lines and one of the data lines;
a scan driver which scans the scan lines; and
the display driver as defined in claim 20 which drives the data lines.

27. An electro-optical device comprising:
a plurality of scan lines;
a plurality of data lines;
a pixel electrode specified by one of the scan lines and one of the data lines;
a scan driver which scans the scan lines; and
the display driver as defined in claim 21 which drives the data lines.

28. An electronic instrument comprising the display driver as defined in claim 19.

29. An electronic instrument comprising the display driver as defined in claim 20.

30. An electronic instrument comprising the display driver as defined in claim 21.

31. An electronic instrument comprising the electro-optical device as defined in claim 25.

32. An electronic instrument comprising the electro-optical device as defined in claim 26.

33. An electronic instrument comprising the electro-optical device as defined in claim 27.
